(19) United States
(12) Patent Application Publication
(10) Pub. No.: US 2025/0310289 A1
(43) Pub. Date: Oct. 2, 2025

(54) SYSTEM AND METHOD OF OPERATING A MUTUALLY WHITELISTED MESSAGING NETWORK

(71) Applicant: Amod Ashok Dange, Mountain View, CA (US)

(72) Inventor: Amod Ashok Dange, Mountain View, CA (US)

(21) Appl. No.: 19/239,852

(22) Filed: Jun. 16, 2025

Related U.S. Application Data
(63) Continuation-in-part of application No. 18/783,017, filed on Jul. 24, 2024.
Application No. 18/783,017 is a continuation-in-part of application No. 17/481,468, filed on Sep. 22, 2021, now Pat. No. 12,072,963.
Application No. 17/481,468 is a continuation-in-part of application No. 17/018,273, filed on Sep. 11, 2020, now Pat. No. 11,582,032.
(60) Provisional application No. 62/906,080, filed on Sep. 25, 2019.
(60) Provisional application No. 62/954,591, filed on Dec. 29, 2019.
(60) Provisional application No. 63/029,717, filed on May 26, 2020.

(51) Int. Cl. H04L 51/212; H04L 9/08

(52) U.S. Cl. CPC H04L 51/212; H04L 9/085; H04L 9/0866

(57) ABSTRACT

A system and method for operating a mutually whitelisted messaging network is configured for registering users using biometric samples to generate a Secret-Key (SKA1), and creating a Gated-Email-Address (GEA) on a System-Controlled-Domain associated with the Secret-Key as the user's Public Key. The system facilitates connections through encoded unique invitations readable only by the System-App. When a recipient installs the app, their biometric samples generate their own Secret-Key (SKB1) and Gated-Email-Address (GEB). The system validates the invitation, generates relationship-specific Shared Secrets using cryptographic algorithms, and appends records to each user's Whitelist reflecting mutual messaging permissions. Users can specify granular permission settings for contact sharing, requiring explicit consent before third parties receive contact info. Messages are implemented as stateful objects that update as participants interact, instead of creating separate replies. Security measures prevent traditional email protocols from sending to Gated-Email-Addresses, ensuring all communication occurs within the permission-based system.

### CROSS-REFERENCE TO RELATED APPLICATIONS AND PRIORITY

The present application is a Continuation in Parts (CIP) application of U.S. Complete application Ser. No. 18/783,017, filed on Jul. 24, 2024 entitled “System and method for managing tokenized Personally-Identifiable-Information”, which claims priority from U.S. Complete application Ser. No. 17/481,468, filed on Sep. 22, 2021 entitled “System and method for affixing a signature using biometric authentication”, which claims priority from US Complete application Ser. No. 17/018,273 filed on Sep. 11, 2020 entitled “System and method for sharing user preferences without having the user reveal their identity”, which claims priority from U.S. Provisional Application No. 62/906,080 filed on Sep. 25, 2019 entitled “Method and system of managing personal and business information”, the U.S. Provisional Application No. 62/954,591 filed on Dec. 29, 2019 entitled “Method and system for anonymously matching consumers and businesses”, and also claims priority from U.S. Provisional Application No. 63/029,717 filed on May 26, 2020 entitled “Method and system of storing identity and signature using the human body as a node.”

### TECHNICAL FIELD

The present subject matter described herein, in general, relates to a system and a method of secure messaging and communication networks. More specifically, the present subject matter discloses the system and method of building a mutually whitelisted messaging network using biometric authentication to establish trusted connections between users while preventing unauthorized communications.

### BACKGROUND

Since the early days of the internet era, emails have been an indispensable communication tool. However, when the email protocol was first designed, there was no consideration given to verifying the identities of the people sending and receiving email messages. Additionally, the protocol was focused on making it easier for people to be discoverable and reachable by members of the public. To this day, people have a common email address at which anyone can send them an email. Consequently, as the owner of an email address, you have no control over who has the ability to send you an email. As long as someone knows your email address, they can send you an email. You have no way of pre-emptively blocking the first unsolicited email from a recipient. Only after receiving the first unsolicited message, can you “mark the email as spam” and create a filter to file it away in the spam folder.

This fundamental design flaw in email systems has led to numerous problems that affect users daily. Spam has become ubiquitous because email addresses are easily shared without the owner's consent or knowledge. Even when users mark unsolicited emails as spam and request to be removed from mailing lists, there is no robust mechanism to enforce these unsubscribe requests, leading to continued unwanted communications.

Furthermore, the lack of authentication in traditional email systems means that the identities of senders and receivers are not verified, creating significant security vulnerabilities. This has given rise to phishing attacks, where malicious actors can easily pretend to be legitimate entities to fraudulently obtain sensitive information from unsuspecting users.

The stateless nature of email messages presents another significant issue. Email threads become continuous chains of appended objects, resulting in cluttered presentations full of redundant messages that are tedious to read and digest. Similarly, attachments are often included multiple times throughout email chains, causing unnecessary data traffic and visual clutter.

Current email systems also lack role-based access capabilities, preventing the assignment of participant roles such as author, editor, or viewer. They cannot trigger actions across the network directly, often requiring users to follow potentially malicious links to external systems. Moreover, email messages are not inherently connected to transaction networks, necessitating redirection to separate, often unverified applications.

The client-server architecture of email systems results in multiple recipients reading different copies of the same message rendered on their local machines. This prevents dynamic interaction between recipients, as responses are merely appended and copies sent to each recipient, exacerbating the poor signal-to-noise ratio.

Most problematically, current email protocols permit contact-sharing without consent. A person receives emails from everyone at the same address, and the protocol does not require a first person's consent for a second person to share the first person's email address with a third person. This is routinely exploited by entities sending unsolicited messages to unsuspecting users.

Additionally, traditional email systems lack rule-based permissioning. Users cannot set rules about who can message them, such as allowing only second-degree connections but not third. This prevents granular control over one's communication channels.

These numerous design flaws in traditional email systems highlight the need for a fundamentally different approach to digital communications. The present invention addresses these issues by creating a mutually whitelisted messaging network built on biometric authentication and cryptographic principles.

### SUMMARY

This summary introduces concepts related to a system and method of operating a mutually whitelisted messaging network. The concepts are further described in the detailed description. This summary is not intended to identify essential features of the claimed subject matter nor limit its scope.

In one implementation, a system for operating a mutually whitelisted messaging network is disclosed. The system comprises a processor and a memory coupled to the processor. The processor is configured to execute instructions stored in the memory for receiving, by a registration module, a set of biometric samples from a User A via a System-App installed on User A's device. Further, the processor is configured to execute instructions stored in the memory for processing, by a key generation module, the set of biometric samples to generate a Secret-Key (SKA1) for the User A. The Secret-Key (SKA1) is unique to the User A. Further, the processor is configured to execute instructions stored in the memory for generating, by an address generation module, a Gated-Email-Address (GEA) for the User A by creating a unique email address on a System-Controlled-Domain and associating the unique email address with the Secret-Key (SKA1). The unique email address is treated as the Gated-Email-Address (GEA), wherein the Gated-Email-Address (GEA) is the User A's Public Key. Further, the processor is configured to execute instructions stored in the memory for receiving, by an invitation module, a first connection request from User A to connect with User B. Further, the processor is configured to execute instructions stored in the memory for generating, by the invitation module, a unique invitation and encoding the unique invitation to generate an encoded unique invitation. The encoded unique invitation is configured to be readable only by the System-App. Further, the processor is configured to execute instructions stored in the memory for transmitting, by a communication module, the encoded unique invitation to User B. The encoded unique invitation includes instructions for User B to download and install the System-App. Further, the processor is configured to execute instructions stored in the memory for detecting, by an onboarding module, when User B installs the System-App and captures User B's biometric samples. Further, the processor is configured to execute instructions stored in the memory for processing, by the key generation module, User B's biometric samples to generate a Secret-Key (SKB1) for the User B, wherein the Secret-Key (SKB1) is unique to the User B. Further, the processor is configured to execute instructions stored in the memory for generating, by the address generation module, a Gated-Email-Address (GEB) for User B by creating a unique address on the System-Controlled-Domain and associating the Gated-Email-Address (GEB) with the generated Secret-Key (SKB1), wherein the Gated-Email-Address (GEB) is User B's Public Key. Further, the processor is configured to execute instructions stored in the memory for receiving, by a connection module, data from the System-App on User B's device indicating that User B has received and decoded the encoded unique invitation. Further, the processor is configured to execute instructions stored in the memory for validating, by the connection module, the encoded unique invitation sent by User A to User B. Further, the processor is configured to execute instructions stored in the memory for generating, by a cryptographic module, a Shared Secret (ABSS) specific to User A's relationship with User B by applying a standard cryptographic algorithm. Further, the processor is configured to execute instructions stored in the memory for generating, by the cryptographic module, a Shared Secret (BASS) specific to User B's relationship with User A by applying the standard cryptographic algorithm. Further, the processor is configured to execute instructions stored in the memory for appending, by the connection module, a Record (RAB) to a Whitelist (WA) of User A, wherein the Record (RAB) reflects User A's permission to User B for sending messages to User A. Further, the processor is configured to execute instructions stored in the memory for appending, by the connection module, a Record (RBA) to a Whitelist (WB) of User B, wherein the Record (RBA) reflects User B's permission to User A for sending messages to User B. Further, the processor is configured to execute instructions stored in the memory for provisioning, by a messaging module, User A and User B to exchange messages based on Whitelist (WA) and Whitelist (WB).

In one implementation, a method for operating a mutually whitelisted messaging network is disclosed. The method comprises steps of receiving, by a registration module, a set of biometric samples from a User A via a System-App installed on User A's device. Further, the method comprises steps of processing, by a key generation module, the set of biometric samples to generate a Secret-Key (SKA1) for the User A, wherein the Secret-Key (SKA1) is unique to the User A. Further, the method comprises steps of generating, by an address generation module, a Gated-Email-Address (GEA) for the User A by creating a unique email address on a System-Controlled-Domain and associating the unique email address with the Secret-Key (SKA1), wherein the unique email address is treated as the Gated-Email-Address (GEA), wherein the Gated-Email-Address (GEA) is the User A's Public Key. Further, the method comprises steps of receiving, by an invitation module, a first connection request from User A to connect with User B. Further, the method comprises steps of generating, by the invitation module, a unique invitation and encoding the unique invitation to generate an encoded unique invitation, wherein the encoded unique invitation is configured to be readable only by the System-App. Further, the method comprises steps of transmitting, by a communication module, the encoded unique invitation to User B, wherein the encoded unique invitation includes instructions for User B to download and install the System-App. Further, the method comprises steps of detecting, by an onboarding module, when User B installs the System-App and captures User B's biometric samples. Further, the method comprises steps of processing, by the key generation module, User B's biometric samples to generate a Secret-Key (SKB1) for the User B, wherein the Secret-Key (SKB1) is unique to the User B. Further, the method comprises steps of generating, by the address generation module, a Gated-Email-Address (GEB) for User B by creating a unique address on the System-Controlled-Domain and associating the Gated-Email-Address (GEB) with the generated Secret-Key (SKB1), wherein the Gated-Email-Address (GEB) is User B's Public Key. Further, the method comprises steps of receiving, by a connection module, data from the System-App on User B's device indicating that User B has received and decoded the encoded unique invitation. Further, the method comprises steps of validating, by the connection module, the encoded unique invitation sent by User A to User B. Further, the method comprises steps of generating, by a cryptographic module, a Shared Secret (ABSS) specific to User A's relationship with User B by applying a standard cryptographic algorithm. Further, the method comprises steps of generating, by the cryptographic module, a Shared Secret (BASS) specific to User B's relationship with User A by applying the standard cryptographic algorithm. Further, the method comprises steps of appending, by the connection module, a Record (RAB) to a Whitelist (WA) of User A, wherein the Record (RAB) reflects User A's permission to User B for sending messages to User A. Further, the method comprises steps of appending, by the connection module, a Record (RBA) to a Whitelist (WB) of User B, wherein the Record (RBA) reflects User B's permission to User A for sending messages to User B. Further, the method comprises steps of provisioning, by a messaging module, User A and User B to exchange messages based on Whitelist (WA) and Whitelist (WB).

In one implementation, a computer program product for operating a mutually whitelisted messaging network is disclosed. The computer program product comprises a non-transitory computer-readable storage medium having program instructions embodied therewith, wherein the program instructions are executable by a processor for receiving, by a registration module, a set of biometric samples from a User A via a System-App installed on User A's device. Further, the operations comprise steps of processing, by a key generation module, the set of biometric samples to generate a Secret-Key (SKA1) for the User A, wherein the Secret-Key (SKA1) is unique to the User A. Further, the operations comprise steps of generating, by an address generation module, a Gated-Email-Address (GEA) for the User A by creating a unique email address on a System-Controlled-Domain and associating the unique email address with the Secret-Key (SKA1), wherein the unique email address is treated as the Gated-Email-Address (GEA), wherein the Gated-Email-Address (GEA) is the User A's Public Key. Further, the operations comprise steps of receiving, by an invitation module, a first connection request from User A to connect with User B. Further, the operations comprise steps of generating, by the invitation module, a unique invitation and encoding the unique invitation to generate an encoded unique invitation, wherein the encoded unique invitation is configured to be readable only by the System-App. Further, the operations comprise steps of transmitting, by a communication module, the encoded unique invitation to User B, wherein the encoded unique invitation includes instructions for User B to download and install the System-App. Further, the operations comprise steps of detecting, by an onboarding module, when User B installs the System-App and captures User B's biometric samples. Further, the operations comprise steps of processing, by the key generation module, User B's biometric samples to generate a Secret-Key (SKB1) for the User B, wherein the Secret-Key (SKB1) is unique to the User B. Further, the operations comprise steps of generating, by the address generation module, a Gated-Email-Address (GEB) for User B by creating a unique address on the System-Controlled-Domain and associating the Gated-Email-Address (GEB) with the generated Secret-Key (SKB1), wherein the Gated-Email-Address (GEB) is User B's Public Key. Further, the operations comprise steps of receiving, by a connection module, data from the System-App on User B's device indicating that User B has received and decoded the encoded unique invitation. Further, the operations comprise steps of validating, by the connection module, the encoded unique invitation sent by User A to User B. Further, the operations comprise steps of generating, by a cryptographic module, a Shared Secret (ABSS) specific to User A's relationship with User B by applying a standard cryptographic algorithm. Further, the operations comprise steps of generating, by the cryptographic module, a Shared Secret (BASS) specific to User B's relationship with User A by applying the standard cryptographic algorithm. Further, the operations comprise steps of appending, by the connection module, a Record (RAB) to a Whitelist (WA) of User A, wherein the Record (RAB) reflects User A's permission to User B for sending messages to User A. Further, the operations comprise steps of appending, by the connection module, a Record (RBA) to a Whitelist (WB) of User B, wherein the Record (RBA) reflects User B's permission to User A for sending messages to User B. Further, the operations comprise steps of provisioning, by a messaging module, User A and User B to exchange messages based on Whitelist (WA) and Whitelist (WB).

### BRIEF DESCRIPTION OF DRAWINGS

The detailed description is described with reference to the accompanying Figures. The same numbers are used throughout the drawings to refer to features and components.

FIG. 1 illustrates a network implementation 100 of a System 101 for operating a mutually whitelisted messaging network, in accordance with an embodiment of the present disclosure.

FIG. 2 illustrates components of the System 101 for operating a mutually whitelisted messaging network, in accordance with an embodiment of the present disclosure.

FIG. 3 illustrates a method 300 for operating a mutually whitelisted messaging network, in accordance with an embodiment of the present disclosure.

FIG. 4 illustrates a method 400 for user registration using biometric samples, in accordance with an embodiment of the present disclosure.

FIG. 5 illustrates a method 500 for connection establishment between users, in accordance with an embodiment of the present disclosure.

FIG. 6 illustrates a method 600 for contact sharing with consent among users, in accordance with an embodiment of the present disclosure.

FIG. 7 illustrates a method 700 for permission revocation in the mutually whitelisted messaging network, in accordance with an embodiment of the present disclosure.

FIG. 8 illustrates a method 800 for implementing messaging as stateful objects, in accordance with an embodiment of the present disclosure.

FIG. 9 illustrates a method 900 for rule-based permissioning in the mutually whitelisted messaging network, in accordance with an embodiment of the present disclosure.

FIG. 10 illustrates a method 1000 for security enforcement against traditional email protocols, in accordance with an embodiment of the present disclosure.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

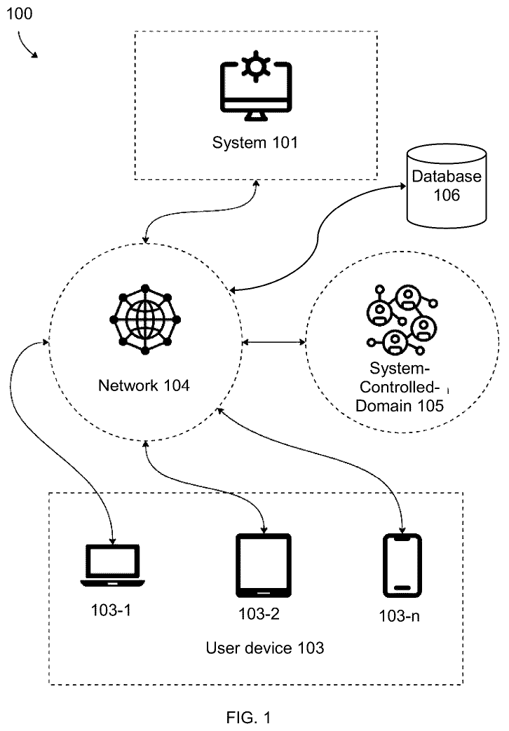

Referring to FIG. 1, implementation 100 of System 101 for operating a mutually whitelisted messaging network is illustrated, in accordance with an embodiment of the present subject matter. In one embodiment, the System 101 may comprise a processor and a memory. Further, the System 101 may be connected to user devices through a network 104. It may be understood that the System 101 may be communicatively coupled with multiple users through one or more user devices 103-1, 103-2, 103-3 . . . , 103-n collectively referred to as user device 103. The System 101 is configured to register users, authenticate users using biometric data, enable secure message exchange between mutually whitelisted users, and enforce permission-based messaging, all while preserving user privacy through the use of biometric-based cryptographic techniques.

In one embodiment, the network 104 may be a cellular communication network used by user devices 103 such as mobile phones, tablets, or other biometric-enabled devices. In one embodiment, the network may be the Internet. The user device 103 may be any electronic device with biometric scanning capabilities, communication capabilities, and secure storage. The System-Controlled-Domain 105 is a server component that hosts the unique email addresses generated for users. The System 101 may be configured to register users over the System 101. Further, the System 101 may be configured to authenticate the user each time the user makes a request to access the System 101, using biometric data and cryptographic techniques.

In one embodiment, the user devices 103 may support communication over one or more types of networks in accordance with the described embodiments. For example, some user devices and networks may support communications over a Wide Area Network (WAN), the Internet, a telephone network (e.g., analog, digital, POTS, PSTN, ISDN, xDSL), a mobile telephone network (e.g., CDMA, GSM, NDAC, TDMA, E-TDMA, NAMPS, WCDMA, CDMA-2000, UMTS, 3G, 4G), a radio network, a television network, a cable network, an optical network (e.g., PON), a satellite network (e.g., VSAT), a packet-switched network, a circuit-switched network, a public network, a private network, and/or other wired or wireless communications network configured to carry data. The aforementioned user devices 103 and network 104 may support wireless local area network (WLAN) and/or wireless metropolitan area network (WMAN) data communications functionality in accordance with Institute of Electrical and Electronics Engineers (IEEE) standards, protocols, and variants such as IEEE 802.11 (“WiFi”), IEEE 802.16 (“WiMAX”), IEEE 802.20x (“Mobile-Fi”), and others.

In one embodiment, the user devices 103 are equipped with biometric scanning capabilities, such as facial recognition cameras, fingerprint scanners, or other biometric sensors. Furthermore, the user devices 103 are also enabled to securely store and process cryptographic keys. The user devices 103 are configured for storing Secret-Keys (SKA1/SKB1), Gated-Email-Addresses (GEA/GEB), and Whitelists (WA/WB) used in the authentication and messaging processes. The System 101 maintains a Database 106, which stores user records and their associated Gated-Email-Addresses as well as permission settings for contact sharing.

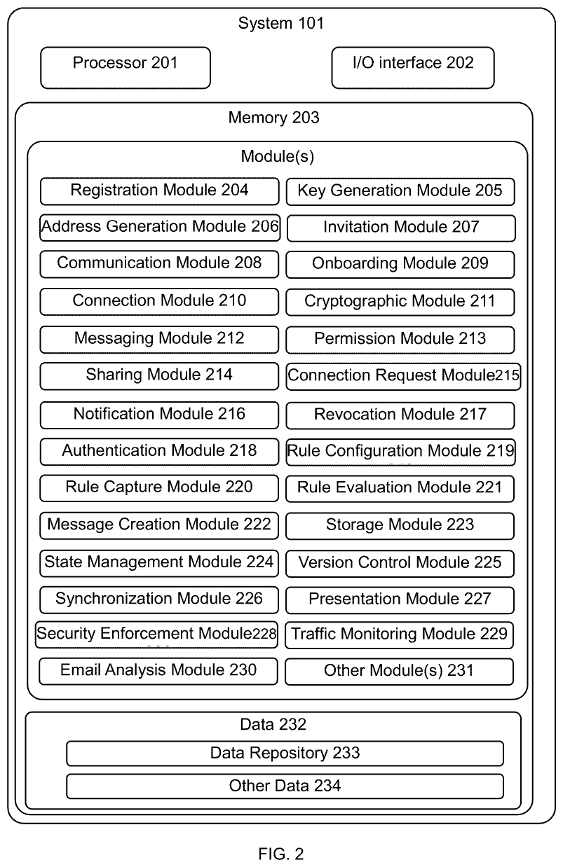

In one embodiment, the System-App installed on user devices 103 provides the interface for users to register, connect with other users, manage their messaging permissions, and exchange secure messages. The System 101 supports all users equally, allowing them to register, authenticate, and exchange messages securely through their mutually established whitelists. The System 101 is designed to maintain user privacy throughout the entire messaging process, allowing users to communicate only with explicitly approved contacts. Further, the System 101 also supports rule-based permissioning and stateful message objects. The process of user registration and the connection establishment processes are further illustrated with the block diagram in FIG. 2.

Referring now to FIG. 2, various components of the System 101 are illustrated, in accordance with an embodiment of the present subject matter. As shown, the System 101 may include at least one processor 201 and a memory 203. The memory consists of a set of modules. The set of modules may include a Registration Module 204, a Key Generation Module 205, an Address Generation Module 206, an Invitation Module 207, a Communication Module 208, an Onboarding Module 209, a Connection Module 210, a Cryptographic Module 211, a Messaging Module 212, a Permission Module 213, a Sharing Module 214, a Connection Request Module 215, a Notification Module 216, a Revocation Module 217, an Authentication Module 218, a Rule Configuration Module 219, a Rule Capture Module 220, a Rule Evaluation Module 221, a Message Creation Module 222, a Storage Module 223, a State Management Module 224, a Version Control Module 225, a Synchronization Module 226, a Presentation Module 227, a Security Enforcement Module 228, a Traffic Monitoring Module 229, an Email Analysis Module 230, and Other Module(s) 231. In one embodiment, the at least one processor 201 is configured to fetch and execute computer-readable instructions, stored in the Memory 203, corresponding to each module.

In one embodiment, the Memory 203 may include any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and memory cards.

In one embodiment, the programmed instructions may include routines, programs, objects, components, data structures, etc., which perform particular tasks, functions, or implement particular abstract data types. The Data 232 may comprise a Data Repository 233, and Other Data 234. The Other Data 234, amongst other things, serves as a repository for storing data processed, received, and generated by one or more components and programmed instructions. The Data Repository 233 may include user records, Gated-Email-Addresses, Whitelists, permission settings, and other system data. The working of the System 101 will now be described in detail referring to FIGS. 1 and 2.

In one embodiment, the Registration Module 204 is responsible for registering each user in the mutually whitelisted messaging network. When a new user, for example User A, downloads and installs the System-App on their User Device 103, the Registration Module 204 initiates the registration process. The System-App prompts User A to provide biometric samples, which may include facial scans, fingerprints, voice samples, retina scans, or other biometric factors. For instance, User A might be asked to look into the device's camera for a facial scan or place their finger on the device's fingerprint sensor. These biometric samples form the foundation of the system's secure identity verification mechanism, as they cannot be easily stolen or replicated like traditional passwords.

In one embodiment, the Key Generation Module 205 processes the biometric samples provided by User A to generate a Secret-Key (SKA1) that is unique to User A. This processing involves three main steps. First, the Key Generation Module 205 extracts distinctive biometric features from the samples, such as facial geometry points, fingerprint minutiae, or voice pattern characteristics. Second, the extracted features are converted into a digital representation, typically a mathematical vector or matrix that captures the unique aspects of the user's biometrics. Finally, the Key Generation Module 205 applies a one-way transformation (such as a cryptographic hash function) to this digital representation to generate the Secret-Key (SKA1). This transformation ensures that even if someone obtains the Secret-Key (SKA1), they cannot reverse-engineer it to recreate the original biometric data, thereby protecting User A's biometric privacy. For example, if User A provides a face sample, the system might extract ridge patterns and minutiae points, convert these into a digital format, and then apply a transformation to produce a 256-bit Secret-Key that is uniquely tied to User A but does not contain the actual face image data.

In one embodiment, the Address Generation Module 206 is responsible for creating a Gated-Email-Address (GEA) for User A. Unlike traditional email addresses that are accessible to anyone who knows them, a Gated-Email-Address functions as a Public Key in a public-private key cryptography system. The Address Generation Module 206 first creates a unique email address on a System-Controlled-Domain, for example, “userA.78f29@securedomain.com”. This address is then cryptographically associated with User A's Secret-Key (SKA1), creating a binding between the user's biometric identity and their messaging address. This association enables the System 101 to verify message origins and ensure only authorized users can communicate. The Gated-Email-Address (GEA) represents User A's Public Key in the system, allowing other users to reference User A without accessing their private biometric information. For instance, if User B wants to connect with User A, they would use User A's Gated-Email-Address rather than any personal identifier.

The technical advantage of this approach is significant. Unlike traditional email addresses that anyone can send messages to once they know the address, the Gated-Email-Address requires explicit permission from the owner before messages can be received. This fundamentally changes the dynamics of digital communication, eliminating the possibility of unsolicited messages (spam) and enhancing user privacy and control.

In one embodiment, the Invitation Module 207 facilitates the connection process between users. When User A wants to connect with User B, User A sends a connection request through the System-App. The Invitation Module 207 receives this request and generates a unique invitation code specifically for this connection attempt. This invitation code contains encrypted information about User A and the connection request. The Invitation Module 207 then encodes this invitation to ensure it can only be decoded and processed by the System-App. This encoding mechanism prevents third-party applications from intercepting or misusing the invitation. For example, the invitation might be encoded as a special URL or QR code that contains encrypted connection parameters only recognizable by the System-App.

In one embodiment, the Communication Module 208 handles the transmission of the encoded unique invitation from User A to User B. This might occur through various channels such as email, SMS, or another messaging platform. Importantly, the invitation includes instructions for User B to download and install the System-App if they haven't already done so. For example, if User B receives the invitation via email, it might contain text like: “User A would like to connect with you securely. To accept this invitation, download the System-App from [app store link] and scan the enclosed QR code.” This approach ensures that all participants in the messaging network are using the same secure platform with consistent security measures.

In one embodiment, the Onboarding Module 209 detects when User B installs the System-App and guides them through the initial setup process. When User B opens the System-App for the first time after installation, the module prompts them to provide their biometric samples. These samples might include facial scans, fingerprints, or other supported biometric factors. The Onboarding Module 209 captures these samples and passes them to the Key Generation Module 205, which follows the same process described earlier to generate User B's Secret-Key (SKB1). This ensures that each user in the System 101 has a unique biometric-derived key that serves as the foundation of their secure identity.

In one embodiment, the Connection Module 210 is responsible for establishing the secure connection between users once the invitation process is complete. After User B installs the System-App and provides their biometric samples, the Connection Module 210 receives data from User B's device indicating that they have received and decoded the unique invitation from User A. The Connection Module 210 then validates this invitation to ensure it hasn't been tampered with and is still valid. This validation might include checking that the invitation hasn't expired, wasn't already used, and contains valid user information. Once validated, the Connection Module 210 proceeds to establish the mutual whitelisting between User A and User B, which forms the basis of their ability to exchange messages.

In one embodiment, the Cryptographic Module 211 generates the secure cryptographic elements needed for the mutually whitelisted connection. For each connection between two users, the Cryptographic Module 211 generates two separate Shared Secrets using a standard cryptographic algorithm such as Diffie-Hellman key exchange or Elliptic Curve Cryptography. Specifically, Cryptographic Module 211 generates a Shared Secret (ABSS) for User A's relationship with User B and a separate Shared Secret (BASS) for User B's relationship with User A. These two distinct secrets ensure that each direction of communication has its own secure channel. For example, when User A sends a message to User B, it would be encrypted using the ABSS, and when User B responds, their message would be encrypted using the BASS. This approach provides perfect forward secrecy, ensuring that if one communication direction is compromised, the other remains secure.

In one embodiment, after the Shared Secrets are generated, the Connection Module 210 updates the respective user Whitelists. It appends a Record (RAB) to User A's Whitelist (WA), which explicitly indicates that User A has granted User B permission to send messages to them. Similarly, it appends a Record (RBA) to User B's Whitelist (WB), reflecting User B's permission for User A to send them messages. These whitelist records are crucial to the system's permission-based messaging model, as they clearly document which users have permission to communicate with each other. For instance, if User C attempts to send a message to User A but there is no corresponding record in User A's whitelist, the System 101 would automatically reject the message attempt.

In one embodiment, the Messaging Module 212 enables the actual exchange of messages between connected users. Once User A and User B have established their mutual connection with corresponding whitelist entries, the Messaging Module 212 provisions them to exchange messages. This provisioning includes setting up the necessary channels, protocols, and encryption methods for secure communication. When User A sends a message to User B, the Messaging Module 212 first checks User B's Whitelist to confirm that User A has permission to message User B. If confirmed, the message is encrypted using the appropriate Shared Secret and delivered to User B. This whitelist verification happens for every message/email, ensuring continuous enforcement of user-defined communication permissions.

The technical advantage of this mutual whitelisting approach is that it creates a permission-based messaging network where communication can only occur with explicit consent from both parties. This eliminates spam, prevents phishing attempts, and gives users complete control over who can contact them. Furthermore, the use of biometric-derived keys ensures that the identities of all participants are authenticated, preventing impersonation and identity fraud.

In one embodiment, the Permission Module 213 allows users to specify detailed settings for how their contact information can be shared with others. For example, User A can access profile settings in the System-App and define specific permission rules. The specific permission rules may include designating specific users who are authorized to share User A's Gated-Email-Address (GEA) with others (e.g., “Only User B and User C can share my contact”), defining categories of third-party users who may receive User A's contact information (e.g., “Only users from my company domain” or “Only users with verified professional accounts”) and specifying whether connection requests resulting from such sharing require automatic or manual approval (e.g., “Automatically approve connection requests from colleagues shared by my manager, but require manual approval for others”). These granular permissions give users unprecedented control over how their contact information spreads through the network.

In one embodiment, the Permission Module 213 stores these permission settings in association with User A's profile in a secure database. These settings are encrypted and can only be accessed through proper authentication within the System-App. This ensures that User A's preferences are consistently applied across all sharing attempts and cannot be circumvented.

In one embodiment, the Sharing Module 214 manages the process when one user wants to share another user's contact information. For instance, if User B wants to share User A's contact with User C, User B would initiate a sharing request through the System-App. The Sharing Module 214 receives this request and works with the Permission Module 213 to retrieve User A's permission settings from the secure database. The Sharing Module 214 may then compare the sharing request parameters against User A's permission settings to determine if the sharing is authorized. This comparison might involve checking if User B is on User A's list of authorized sharers, if User C fits into the categories User A has approved, and what type of approval is required. If the sharing request is authorized based on User A's preferences, the Sharing Module 214 transmits User A's Gated-Email-Address (GEA) to User C. Additionally, the Sharing Module 214 records the complete details of this sharing transaction in an audit log, including the identities of all parties involved, the timestamp, and the outcome of the permission check. This audit trail provides transparency and accountability in how contact information propagates through the network.

In one embodiment, the Connection Request Module 215 handles the process that occurs after a user's contact has been shared. Continuing the example, after User C receives User A's Gated-Email-Address (GEA), they might want to establish a direct connection. User C would then send a connection request to User A through the System-App. This request includes User C's own Gated-Email-Address (GEC) and a reference to User B as the source of the contact. The Connection Request Module 215 receives this request and initiates the verification process through the Permission Module 213.

In one embodiment, the Permission Module 213 verifies whether User C meets the criteria specified in User A's permission settings through a multi-step process. For example, the Permission Module 213 may check the relationship between User B (the sharer) and User C (the recipient) to confirm they have a valid connection, evaluate any category-based rules that apply to User C, such as organizational affiliation or user attributes, and determine whether User A's settings allow for automatic approval of this particular connection request or require manual intervention. This comprehensive verification ensures that User A's preferences are respected throughout the network expansion process.

In one embodiment, the Notification Module 216 manages communication about connection requests and other system events. If the Permission Module 213 determines that automatic approval is not authorized for User C's connection request to User A, the Notification Module 216 sends a connection request notification to User A's System-App. This notification includes User C's identity information and explicitly shows the connection path through User B, providing User A with context about how this new contact relates to their existing network. For example, the notification might read: “User C (from Organization XYZ) would like to connect with you. They received your contact from User B (your connection since [date]).” This transparency helps User A make informed decisions about expanding their network.

In one embodiment, upon User A's approval of the connection request, the Cryptographic Module 211 generates the necessary secure elements for this new connection. Specifically, it creates a Shared Secret (ACSS) for User A's relationship with User C and a Shared Secret (CASS) for User C's relationship with User A, using the same standard cryptographic algorithm employed for other connections. Following this, the Connection Module 210 appends the appropriate records to each user's whitelist. For example, a record to User A's Whitelist (WA) reflecting permission for User C to message User A and a record to User C's Whitelist (WC) reflecting permission for User A to message User C may be added. Finally, the Messaging Module 212 provisions User A and User C to exchange messages based on these updated whitelists.

The technical advantage of this consent-based contact sharing mechanism is that it preserves user privacy and control while still enabling network growth. Unlike traditional email or messaging platforms where contact information can be shared without the owner's knowledge or consent, this system ensures that users maintain complete control over who receives their contact information and who can subsequently connect with them. This prevents unwanted contact proliferation while still allowing for the organic growth of professional and personal networks.

In one embodiment, the Revocation Module 217 handles the process when a user decides to revoke another user's permission to send them messages. For example, if User A decides they no longer wish to receive messages from User B, they can initiate a revocation request through the System-App. This might happen if User B is sending unwanted content, if the professional relationship has ended, or for any other reason User A chooses. The Revocation Module 217 receives this request and works with the Authentication Module 218 to validate that the request is genuinely from User A by performing biometric authentication. This verification step prevents unauthorized revocation attempts and ensures that only the account owner can modify their connection permissions.

In one embodiment, once the revocation request is validated, the Connection Module 210 removes the Record (RAB) from User A's Whitelist (WA). This record removal effectively withdraws User A's permission for User B to send messages to User A. Simultaneously, the Cryptographic Module 211 expires the Shared Secret (ABSS) specific to User A's relationship with User B and the Shared Secret (BASS) specific to User B's relationship with User A. This expiration renders the cryptographic keys invalid, preventing any further encrypted communication between the two users. The Messaging Module 212 then updates the messaging permissions to disallow message transmission between User A and User B. Finally, the Notification Module 216 sends a notification to User B informing them that their messaging permission has been revoked by User A. This notification does not require User B's acknowledgment or approval, as the revocation process is unilateral reflecting User A's right to control who can communicate with them.

The technical advantage of this revocation mechanism is that it gives users complete control over their communications at all times. Unlike traditional email where blocking a sender might not be completely effective or where the sender might not be notified of the block, the System 101 provides a definitive and technologically enforced revocation process. Once revoked, it becomes cryptographically impossible for the blocked user to send messages, creating a truly secure and user-controlled communication environment.

In one embodiment, the Rule Configuration Module 219 provides users with powerful options to define granular messaging permission rules. For example, User A can access the rule configuration interface in the System-App and set up specific rules determining which categories of users can send messaging requests to them. These rule options include connection-based rules, such as allowing only first and second-degree connections or extending to include third-degree connections, organizational affiliation rules, such as allowing messages from anyone within their company or specific partner organizations, temporal rules based on connection duration, such as only allowing messages from connections established for more than 30 days, and attribute-based rules, such as allowing messages only from users with verified professional credentials or specific role designations.

In one embodiment, the Rule Capture Module 220 captures these granular messaging permission rules as specified by users through the System-App interface. The Rule Capture Module 220 ensures that the rules are properly formatted, logically consistent, and can be effectively implemented by the system. For example, if User A creates contradictory rules, the Rule Capture Module 220 would flag the inconsistency and prompt for clarification. Once captured, the Permission Module 213 stores these rules in association with User A's profile on the System-App.

In one embodiment, the Rule Evaluation Module 221 processes incoming messaging permission requests by applying the stored rules. When a user attempts to send a message or connection request to User A, the Rule Evaluation Module 221 first extracts relevant attributes of the requesting user, such as their connection degree, organizational affiliation, connection duration, and any other attributes specified in User A's rules. It then retrieves User A's granular messaging permission rules and systematically evaluates the requesting user's attributes against each rule. Through this evaluation, the module determines whether the request satisfies User A's permission criteria. Based on this determination, the Rule Evaluation Module 221 automatically approves or rejects the incoming request, or flags it for manual review when User A's rules specify that manual approval is required for certain categories of requests.

The technical advantage of this rule-based permissioning system is that it provides an unprecedented level of automation and customization in managing communication access. Users can create sophisticated permission frameworks that reflect their unique preferences and professional requirements without having to manually approve or reject each incoming request. This combines the benefits of security and control with the convenience of automation, significantly reducing the administrative burden of managing digital communications.

In one embodiment, the Message Creation Module 222 is part of the implementation of messages as stateful objects. Unlike traditional email where each message and reply are a separate object, the Message Creation Module 222 creates a single message object with a unique identifier when a message is first sent. This message object will contain the initial content but is designed to evolve as the conversation progresses. For example, when User A sends the first message to User B, rather than creating a traditional email message, the System 101 creates a persistent object with a unique identifier (e.g., “MSG-2025-05-20-A2B-001”) that will house the entire conversation thread.

In one embodiment, the Storage Module 223 stores the message object in a storage system that is accessible to all participants in the conversation. This might be implemented as a distributed database or a cloud-based storage solution with appropriate access controls. The important distinction from traditional email is that there is only one copy of the message object, and all participants access this same object rather than having separate copies on their respective devices.

In one embodiment, the State Management Module 224 is responsible for updating the state of the message object as participants interact with it. Instead of creating new message objects for replies, as traditional email systems do, the State Management Module 224 updates the existing message object with new content, status changes, or other interactions. For example, when User B replies to User A's message, their response is added to the original message object as a new state, rather than being created as a separate message. This approach eliminates the redundancy and fragmentation inherent in traditional email threads.

In one embodiment, the Version Control Module 225 tracks all changes to the message object with timestamps and user identifiers. This creates a complete and transparent history of the conversation, showing exactly who said what and when. This tracking enables features like viewing message history, reverting to previous states, or understanding the evolution of a discussion. The Version Control Module 225 ensures that even as the message object changes state, no information is lost and accountability is maintained.

In one embodiment, the Synchronization Module 226 ensures that the message object state is synchronized across all participants' devices. When any participant interacts with the message, the changes are propagated to all other participants in real-time or near-real-time. This synchronization ensures that all users are seeing the same current state of the conversation, eliminating the confusion that can arise in traditional email when participants are responding to different versions of a thread.

In one embodiment, the Presentation Module 227 renders the current state of the message object to each participant. The Presentation Module 227 formats the message object for display in the System-App, showing the conversation in a clean, logical format that eliminates redundant content. For example, instead of showing repeated headers, signatures, and quoted text from previous messages (as is common in email), the Presentation Module 227 displays the conversation as a continuous thread with clear attribution for each contribution. This significantly improves readability and information density compared to traditional email threads.

The technical advantage of implementing messages as stateful objects is transformative for digital communications. It eliminates the redundancy, fragmentation, and confusion of traditional email threads, where content is duplicated across multiple messages and participants often end up with different versions of the conversation. The stateful object approach creates a single source of truth for the conversation, ensures all participants are synchronized, and dramatically improves the signal-to-noise ratio in digital communications. Additionally, this approach significantly reduces data usage and storage requirements by eliminating the redundant storage of the same content across multiple message objects.

In one embodiment, the Security Enforcement Module 228 prevents any attempts to send messages between users through traditional email protocols. This module works with the Traffic Monitoring Module 229 and the Email Analysis Module 230 to ensure that all communication within the system occurs only through the secure, permission-based channels established by the System-App.

In one embodiment, the Traffic Monitoring Module 229 continuously monitors incoming email traffic to the System-Controlled-Domain. For example, if the System-Controlled-Domain is “securedomain.com”, the Traffic Monitoring Module 229 would monitor all incoming SMTP traffic to *@securedomain.com addresses. This monitoring allows the system to intercept any attempts to communicate with Gated-Email-Addresses using traditional email protocols instead of the secure System-App channels.

In one embodiment, the Email Analysis Module 230 identifies messages directed to Gated-Email-Addresses (GEA/GEB) within the incoming traffic. When such messages are detected, rather than delivering them to the intended recipient, the system prevents the delivery. For each blocked message, the Notification Module 216 generates and returns a rejection notice to the sender, explaining that the Gated-Email-Address they attempted to reach requires the use of the System-App and cannot be accessed through traditional email protocols. This enforcement ensures that the security and permission-based nature of the system cannot be circumvented by attempting to use traditional, less secure communication methods.

The technical advantage of this security enforcement mechanism is that it closes a potential vulnerability in the system. Without this enforcement, someone might attempt to bypass the permission-based protections by sending traditional emails directly to the Gated-Email-Addresses. By blocking such attempts and returning clear rejection notices, the system maintains its integrity and ensures that all communication occurs only through the secure, permission-based channels that are central to its design. This creates a truly closed ecosystem where the enhanced security and privacy features cannot be compromised by external protocols.

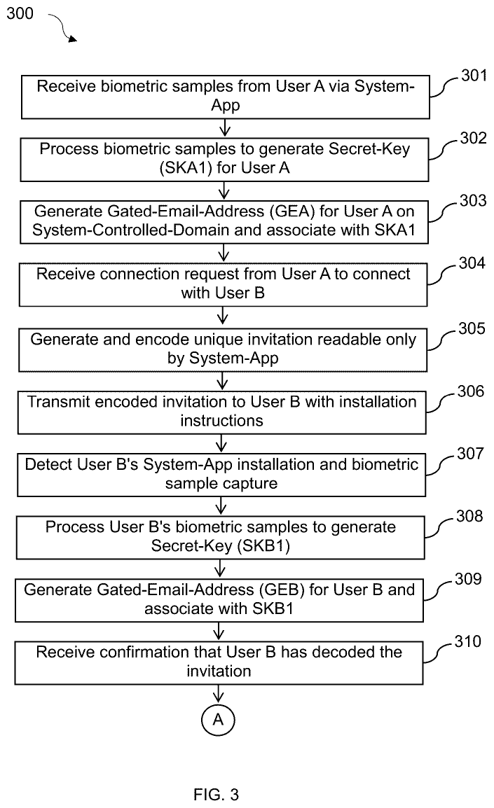

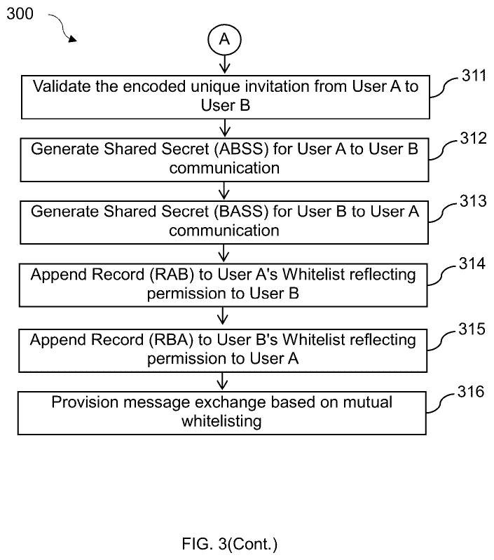

Now referring to FIG. 3, a method 300 for operating a mutually whitelisted messaging network is illustrated, in accordance with an embodiment of the present subject matter.

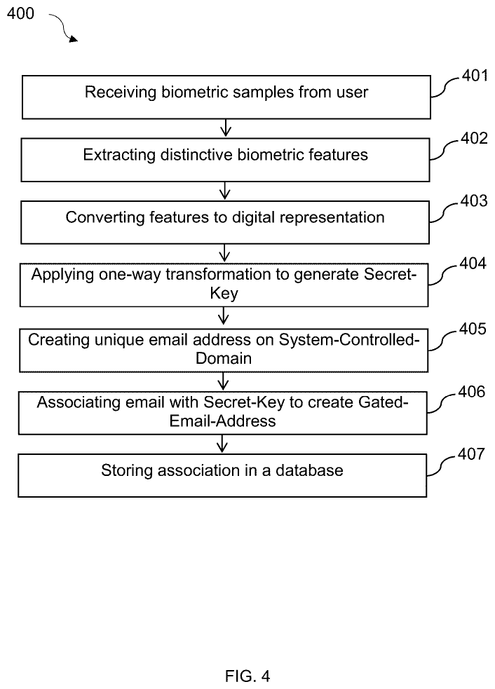

At step 301, the processor 201 may be configured for receiving, by a Registration Module 204, a set of biometric samples from a User A via a System-App installed on User A's device. When a new user initiates the registration process through the System-App, they are guided through providing multiple biometric samples such as facial scans, fingerprints, voice samples, or retina scans. For example, when Sarah downloads and installs the System-App on her smartphone, she is prompted with detailed instructions “Please look at your camera and follow the on-screen guide for a complete facial scan” followed by “Place your index finger on the fingerprint sensor three times to register your fingerprint.” The System-App might also request Sarah to speak a specific phrase for voice recognition. These biometric samples are captured using the device's built-in sensors and are processed locally to protect privacy. The registration process is designed to be user-friendly while capturing high-quality biometric data that will form the foundation of Sarah's secure identity within the messaging network. The detailed steps for user registration using biometric samples are further elaborated with reference to FIG. 4.

At step 302, the processor 201 may be configured for processing, by a Key Generation Module 205, the set of biometric samples to generate a Secret-Key (SKA1) for the User A, wherein the Secret-Key (SKA1) is unique to the User A. The biometric samples provided by Sarah undergo sophisticated processing through a series of algorithms designed specifically for biometric cryptography. First, the system extracts distinctive features from her samples such as facial geometry points, fingerprint minutiae patterns, or voice frequency characteristics creating a comprehensive biometric profile. Next, these extracted features are converted into a standardized digital representation, typically a mathematical vector or matrix of numerical values that precisely capture the unique aspects of Sarah's biometrics. Finally, the System 101 applies a specialized one-way transformation (such as a secure hash function designed for biometric data) to this digital representation, producing a fixed-length cryptographic Secret-Key (SKA1) like “7f4e6a2d1c8b9a0f3e2d1c8b7a6f5e4d . . . ” that is uniquely tied to Sarah's biometrics. This transformation is designed with error tolerance to accommodate slight variations in future biometric readings while maintaining the security property that the original biometric data cannot be reconstructed from the Secret-Key, even if it were compromised. The detailed steps for processing biometric samples to generate Secret-Keys are further elaborated with reference to FIG. 4.

At step 303, the processor 201 may be configured for generating, by an Address Generation Module 206, a Gated-Email-Address (GEA) for the User A by creating a unique email address on a System-Controlled-Domain and associating the unique email address with the Secret-Key (SKA1), wherein the unique email address is treated as the Gated-Email-Address (GEA), wherein the Gated-Email-Address (GEA) is the User A's Public Key. This step involves two critical operations. First, the system generates a unique email address for Sarah on the System-Controlled-Domain, such as “sarah.784fb9@securedomain.com”, where “sarah” may reflect her registered name, “784fb9” is a unique identifier potentially derived from a hash of account details, and “securedomain.com” is the domain exclusively controlled by the system. Second, the system creates a robust cryptographic binding between Sarah's Secret-Key (SKA1) and this email address, effectively transforming it into a Gated-Email-Address that serves as her Public Key in the system's cryptographic infrastructure. This association might be implemented as a digital certificate or cryptographic binding that proves the email address is legitimately controlled by the holder of the corresponding Secret-Key. Unlike traditional email addresses that anyone can send messages to once they know the address, this Gated-Email-Address requires explicit permission before messages can be received, fundamentally transforming the dynamics of digital communication. Other users like Michael will use this Gated-Email-Address to reference Sarah within the system, while the underlying biometric-based authentication remains private and secure. The detailed steps for generating the Gated-Email-Address are further elaborated with reference to FIG. 4.

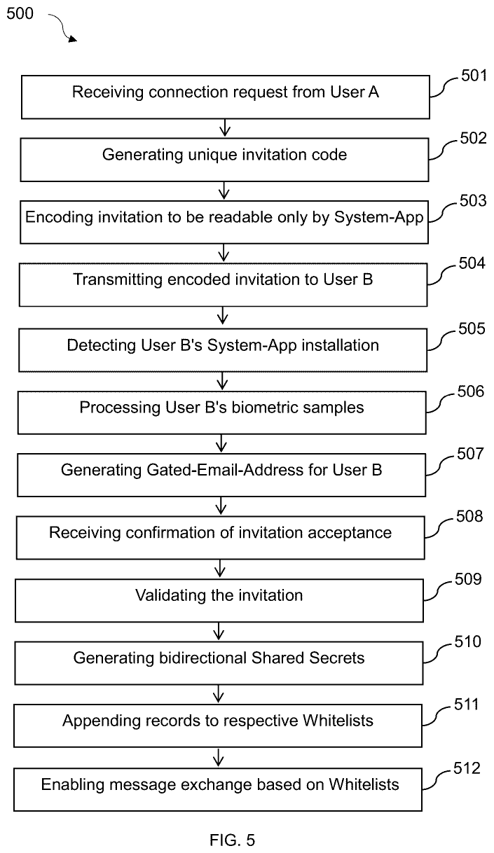

At step 304, the processor 201 may be configured for receiving, by an Invitation Module 207, a first connection request from User A to connect with User B. After successful registration, Sarah decides to establish a secure messaging connection with her colleague Michael. Through the System-App interface, she navigates to a “Connect” or “Add Contact” section and initiates a connection request. Sarah might search for Michael by entering his name, email address, phone number, or another identifier that the System 101 can use to route the invitation. Upon finding Michael or entering his contact information, Sarah taps a “Send Connection Request” button to initiate the formal connection process. The System 101 records her request, including metadata such as the timestamp, initiator (Sarah), target (Michael), and connection context. Unlike traditional messaging platforms where users can immediately start sending messages to any known address, this connection request initiates a comprehensive protocol designed to establish mutual consent before any communication can occur. The detailed steps for the connection establishment process are further elaborated with reference to FIG. 5.

At step 305, the processor 201 may be configured for generating, by the Invitation Module 207, a unique invitation and encoding the unique invitation to generate an encoded unique invitation, wherein the encoded unique invitation is configured to be readable only by the System-App. Upon receiving Sarah's connection request, the system generates a unique invitation code specifically for this connection attempt. This invitation code might follow a format like “INV-SA-MI-2025-05-20-H78B2”, which encodes information about the initiator (Sarah), the recipient (Michael), the timestamp (May 15, 2025), and a unique cryptographic identifier. This invitation is designed to be a one-time token that cannot be reused for other connections and typically includes an expiration time (e.g., valid for 7 days). The System 101 then encrypts this invitation using cryptographic keys known only to the system and encodes it into a format such as a QR code, specialized URL (e.g., “securedomain://connect/Jh7G9Kf3sL0pQ2a . . . ”), or other secure format. This encoding ensures that only the authentic System-App can properly decrypt and process the invitation if someone attempts to scan the QR code with a regular scanner or open the specialized URL with a standard browser, they would not be able to extract or use the connection information. This security mechanism prevents malicious applications from intercepting or tampering with the invitation, even if the initial delivery channel is not inherently secure. The detailed steps for generating and encoding unique invitations are further elaborated with reference to FIG. 5.

At step 306, the processor 201 may be configured for transmitting, by a Communication Module 208, the encoded unique invitation to User B, wherein the encoded unique invitation includes instructions for User B to download and install the System-App. The System 101 sends the encoded invitation to Michael through an available communication channel based on the contact information Sarah provided. If Sarah provided Michael's phone number, the system might send an SMS message stating: “Sarah would like to connect with you on SecureMessaging. To accept this invitation, download the System-App from [app store link] and use this code:” followed by the encoded invitation as a QR code image or specialized link. Alternatively, if an email address was provided, the System 101 would send an email with similar content, potentially including additional information about the secure messaging network and its benefits. The message clearly explains that Michael needs to download and install the System-App to accept the invitation, providing direct links to the appropriate app stores for easy installation. This approach enables the System 101 to leverage existing communication channels for the initial contact while ensuring that the actual connection establishment occurs exclusively through the secure System-App environment, creating a bridge from traditional communication methods to the secure messaging network. The detailed steps for transmitting invitations are further elaborated with reference to FIG. 5.

At step 307, the processor 201 may be configured for detecting, by an Onboarding Module 209, when User B installs the System-App and captures User B's biometric samples. The System 101 actively monitors for the installation of the System-App on Michael's device, particularly in response to the invitation from Sarah. When Michael clicks the provided app store link and installs the System-App, the System identifies this as a response to the specific invitation. Upon first launch, the app detects that it was installed in response to an invitation and guides Michael through the onboarding process, explaining: “You've been invited to connect with Sarah on SecureMessaging. To complete your secure identity setup, we'll need to collect some biometric samples. These will remain on your device and are never stored or transmitted.” The app then walks Michael through the biometric sample collection process, similar to Sarah's experience during registration. He might be prompted to perform a facial scan by following an on-screen guide, place his finger on the device's fingerprint sensor multiple times, or speak a specific phrase for voice recognition. The System 101 captures high-quality samples while providing real-time feedback to ensure proper positioning and clarity. This detection and guided onboarding process ensures that new users joining in response to invitations have a streamlined experience while maintaining the security standards required for the system's biometric authentication framework. The detailed steps for onboarding new users are further elaborated with reference to FIG. 5.

At step 308, the processor 201 may be configured for processing, by the Key Generation Module 205, User B's biometric samples to generate a Secret-Key (SKB1) for the User B, wherein the Secret-Key (SKB1) is unique to the User B. Michael's biometric samples undergo the same sophisticated processing as Sarah's did during her registration. The system extracts distinctive features from his samples such as the spatial relationships between facial landmarks, the patterns of ridges and valleys in his fingerprints, or the unique patterns in his voice and converts these features into a standardized digital format. A specialized one-way transformation is then applied to this digital representation to generate Michael's Secret-Key (SKB1). This Secret-Key is mathematically derived from his biometric characteristics but designed so that the original biometric data cannot be reconstructed, protecting his biometric privacy. The generation process includes error-correction mechanisms that allow the system to regenerate the same Secret-Key from future biometric samples even with slight variations in positioning or conditions. By processing Michael's biometrics in the same manner as all other users, the system ensures that every participant in the network has an equivalently secure identity derived from their unique biological characteristics, creating a network of strongly authenticated individuals without centrally storing sensitive biometric data. The detailed steps for processing biometric samples are further elaborated with reference to FIG. 4.

At step 309, the processor 201 may be configured for generating, by the Address Generation Module 206, a Gated-Email-Address (GEB) for User B by creating a unique address on the System-Controlled-Domain and associating the Gated-Email-Address (GEB) with the generated Secret-Key (SKB1), wherein the Gated-Email-Address (GEB) is User B's Public Key. Following the same process used for Sarah, the system creates a unique email address for Michael on the System-Controlled-Domain, such as “michael.62a7d3@securedomain.com”, where “michael” reflects his name and “62a7d3” is a unique identifier. This address is then cryptographically associated with Michael's Secret-Key (SKB1) to create his Gated-Email-Address (GEB), which serves as his Public Key in the system. This Gated-Email-Address enables other users to reference Michael within the system without having access to his biometric-derived Secret-Key. The technical advantage of creating consistent Gated-Email-Addresses for all users is that it provides a familiar address format while fundamentally transforming the security model from open-by-default to closed-by-default. Each Gated-Email-Address functions as a cryptographically secured endpoint that requires explicit permission before messages can be received, rather than a traditional email address accessible to anyone who knows it. The detailed steps for generating Gated-Email-Addresses are further elaborated with reference to FIG. 4.

At step 310, the processor 201 may be configured for receiving, by a Connection Module 210, data from the System-App on User B's device indicating that User B has received and decoded the encoded unique invitation. When Michael successfully processes the invitation in the System-App either by scanning the QR code, clicking the specialized link, or manually entering the invitation code the app decodes the invitation using the system's cryptographic protocols. The app displays details of the connection request to Michael, such as: “Connection request from: Sarah (sarah.784fb9@securedomain.com)” and prompts him to “Accept” or “Decline” the connection. When Michael reviews this information and taps “Accept,” the System-App sends a secure confirmation back to the system through an encrypted channel. This confirmation includes data such as Michael's acceptance timestamp, his newly created Gated-Email-Address (GEB), device information for security verification, and a digital signature confirming his explicit consent to establish the connection. This confirmation step ensures that both parties Sarah through her initial request and Michael through his acceptance have explicitly consented to establish a secure messaging channel, fulfilling the mutual consent requirement that is central to the system's design. The detailed steps for processing invitations are further elaborated with reference to FIG. 5.

At step 311, the processor 201 may be configured for validating, by the connection module, the encoded unique invitation sent by User A to User B. Before finalizing the connection, the system performs comprehensive security checks on the invitation and its acceptance. It verifies that the invitation code (e.g., “INV-SA-MI-2025-05-20-H78B2”) is legitimate and was indeed issued by the system for a connection between Sarah and Michael. The validation process checks that the invitation hasn't expired based on its timestamp and configured validity period, hasn't already been used in a previous connection attempt, and hasn't been tampered with during transmission by verifying cryptographic signatures. The system also confirms that the acceptance came from the intended recipient by comparing the provided identifier (phone number or email) used in the initial invitation with the account information associated with the acceptance. These validations ensure the integrity of the connection establishment process and prevent various security threats such as invitation forgery, replay attacks, or man-in-the-middle attempts. Only after passing all these validation checks does the system proceed to establish the cryptographic foundations of the secure messaging channel between Sarah and Michael. The detailed steps for validating invitations are further elaborated with reference to FIG. 5.

At step 312, the processor 201 may be configured for generating, by a Cryptographic Module 211, a Shared Secret (ABSS) specific to User A's relationship with User B by applying a standard cryptographic algorithm. With both users authenticated and the invitation validated, the system creates the first of two cryptographic elements needed for secure bidirectional communication. Using a standard cryptographic algorithm such as Elliptic Curve Diffie-Hellman (ECDH), the system generates a Shared Secret (ABSS) specifically for Sarah's messages to Michael. This might be implemented by combining Sarah's Secret-Key (SKA1) with Michael's Public Key (GEB) through the ECDH algorithm, resulting in a unique 256-bit value that will be used to encrypt all messages from Sarah to Michael. This Shared Secret is never transmitted across the network. Instead, it is calculated independently on each user's device using their own Secret-Key and the other user's Public Key. This property provides perfect forward secrecy even if one communication direction is somehow compromised, the other remains secure. The standard cryptographic algorithm is selected for its proven security properties, ensuring that the resulting Shared Secret is computationally infeasible to derive without knowledge of the respective Secret-Keys. The detailed steps for generating relationship-specific Shared Secrets are further elaborated with reference to FIG. 5.

At step 313, the processor 201 may be configured for generating, by the Cryptographic Module 211, a Shared Secret (BASS) specific to User B's relationship with User A by applying the standard cryptographic algorithm. Following the same cryptographic principles used for ABSS, the system generates a separate Shared Secret (BASS) for Michael's messages to Sarah. This Shared Secret is derived using the same standard algorithm (e.g., ECDH) but with the inputs reversed combining Michael's Secret-Key (SKB1) with Sarah's Public Key (GEA). The resulting cryptographic key is entirely distinct from ABSS, ensuring that each direction of communication has its own independent secure channel. This bidirectional approach with separate keys provides several security advantages: it compartmentalizes the communication channels so that a compromise in one direction doesn't affect the other, it enables different security policies to be applied to each direction if needed, and it simplifies key rotation or revocation processes. Like ABSS, the BASS is never directly transmitted across the network but is calculated independently on each device using the respective Secret-Key and Public Key, maintaining the security of the system even if network communications are intercepted. The detailed steps for generating relationship-specific Shared Secrets are further elaborated with reference to FIG. 5.

At step 314, the processor 201 may be configured for appending, by the Connection Module 210, a Record (RAB) to a Whitelist (WA) of User A, wherein the Record (RAB) reflects User A's permission to User B for sending messages to User A. With the cryptographic foundation established, the system creates an explicit permission record documenting Sarah's consent for communication from Michael. The system appends a Record (RAB) to Sarah's Whitelist (WA) that contains comprehensive information about this permission grant. This record might include Michael's Gated-Email-Address (GEB), a timestamp of when the permission was granted, the connection path (direct invitation, in this case), a reference to the associated Shared Secret (ABSS), the current status of the connection (Active), and potentially other metadata such as user-defined labels or categories. For example, Sarah's Whitelist entry for Michael might be structured as “Sender: michael.62a7d3@securedomain.com, Connected: May 20, 2025, 15:17 UTC, Connection Path: Direct, Status: Active, Shared Secret Reference: ABSS-SA-MI-471.” This record serves as the definitive source of truth for messaging permissions within the system every time Michael attempts to send a message to Sarah, the system will check this record to verify his permission before delivering the message. The whitelist approach creates a technical enforcement of the consent-based messaging model that is central to the system's design. The detailed steps for maintaining and updating Whitelists are further elaborated with reference to FIG. 5.

At step 315, the processor 201 may be configured for appending, by the Connection Module 210, a Record (RBA) to a Whitelist (WB) of User B, wherein the Record (RBA) reflects User B's permission to User A for sending messages to User B. Mirroring the process applied to Sarah's Whitelist, the system appends a Record (RBA) to Michael's Whitelist (WB). This record documents Michael's explicit permission for Sarah to send him messages, containing similar information but with the relationship direction reversed: Sarah's Gated-Email-Address (GEA), the timestamp of connection establishment, the connection path, a reference to the Shared Secret (BASS) specific to this direction, and the connection status. This parallel record-keeping ensures that both users have equivalent documentation of their mutual consent to communicate, establishing a balanced relationship where each party has formally granted permission to the other. The symmetrical nature of these whitelist records reflects the system's commitment to mutual consent as the foundation of all communications unlike traditional messaging systems where connections might be unidirectional or asymmetrical in their permission structure. These records serve as persistent documentation of user consent that can be audited, modified, or revoked as needed, providing both technical enforcement and accountability for the permission-based messaging model. The detailed steps for maintaining and updating Whitelists are further elaborated with reference to FIG. 5.

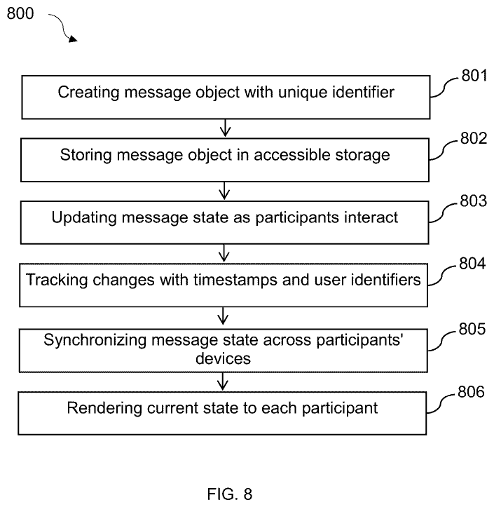

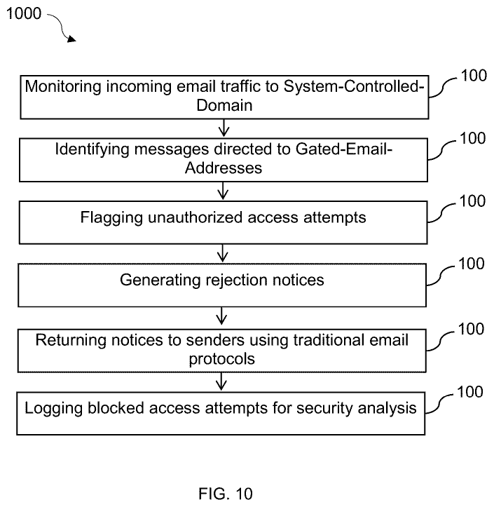

At step 316, the processor 201 may be configured for provisioning, by a Messaging Module 212, User A and User B to exchange messages based on Whitelist (WA) and Whitelist (WB). With the mutual whitelisting complete, the system enables the actual secure message exchange between Sarah and Michael. This provisioning includes setting up all necessary technical components for their communications such as establishing the secure channels based on the respective Shared Secrets (ABSS and BASS), configuring the encryption protocols and message formats, initializing the stateful message objects that will hold their conversations (as detailed in FIG. 8), and activating the permission-checking mechanisms that will verify whitelist entries before each message delivery. When Sarah composes a message to Michael in the System-App, the system first checks Michael's Whitelist (WB) to confirm that she has permission to message him. Finding the appropriate record (RBA), it confirms her authorization, then encrypts her message using the Shared Secret (BASS) and delivers it to Michael. Similarly, when Michael responds, the system checks Sarah's Whitelist (WA), verifies his permission through the record (RAB), encrypts his message using the Shared Secret (ABSS), and delivers it to Sarah. This continuous enforcement of permissions ensures that only mutually approved communications can occur within the system. The technical result is a messaging environment that eliminates spam, prevents phishing, and gives users complete control over who can contact them, fundamentally addressing the problems inherent in traditional email systems as described in the background. The detailed steps for message exchange using stateful objects are further elaborated with reference to FIG. 8, and the security enforcement mechanisms are further detailed in FIG. 10.

Now referring to FIG. 4, a method 400 for user registration using biometric samples is illustrated, in accordance with an embodiment of the present subject matter.

At step 401, the processor 201 may be configured for receiving a set of biometric samples from a user. When a user initiates the registration process in the System-App, they are guided through providing biometric samples. For example, when Sarah registers for the System 101, the app might instruct “Please look directly at the camera and follow the on-screen guide to complete a facial scan.” The System-App presents a face outline and provides real-time feedback to ensure proper positioning and lighting. As Sarah follows the instructions, the System-App captures multiple images of her face from slightly different angles to ensure a comprehensive sample. The System-App might also request a fingerprint sample with instructions like: “Place your index finger on the fingerprint sensor and hold until the scan is complete. Please repeat three times.” The system might collect multiple biometric factors to enhance security, such as combining facial recognition with fingerprint scanning or voice recognition. These samples are processed locally on the device to protect privacy, ensuring that raw biometric data is never transmitted over the network.

At step 402, the processor 201 may be configured for extracting distinctive biometric features from the samples. This step involves sophisticated algorithms that identify and isolate the unique characteristics in the user's biometric samples. For Sarah's facial scan, the system might identify key facial landmarks such as the distance between her eyes, the width of her nose, the contour of her jawline, and dozens of other subtle measurements that collectively create a unique facial “signature.” If Sarah also provided a fingerprint, the system would extract minutiae points (the ridge endings and bifurcations) that make her fingerprint unique. For a voice sample, the system might extract vocal frequency patterns, cadence, and tonal qualities. The extraction process focuses on the distinctive aspects of each biometric factor while filtering out irrelevant variations such as lighting conditions for facial scans or background noise for voice samples. This process transforms raw biometric data into a set of precise measurements and patterns that uniquely identify Sarah without retaining unnecessary personal details.

At step 403, the processor 201 may be configured for converting the extracted features into a digital representation. The distinctive features extracted in the previous step are now transformed into a standardized digital format that can be processed by cryptographic algorithms. For example, Sarah's facial geometry measurements might be converted into a vector or matrix of numerical values. These values precisely define the spatial relationships between her facial features representing the distance from her right eye to the tip of her nose as 2.34 units, the angle of her jawline as 42.7 degrees, and so on. Similarly, her fingerprint minutiae might be represented as coordinates on a grid with directional information. This conversion process creates a compact, mathematical representation of Sarah's biometric identity. The technical advantage of this step is that it standardizes diverse biometric data into a consistent format suitable for cryptographic processing, regardless of whether the original sample was a face, fingerprint, or voice pattern.

At step 404, the processor 201 may be configured for applying a one-way transformation to generate the Secret-Key. This critical step applies cryptographic functions to the digital representation to produce the user's Secret-Key. For Sarah, the system might use a specialized hashing algorithm designed for biometric data that accommodates slight variations in future readings while still producing consistent results. For example, the system might apply a function like the Fuzzy Extractor or Secure Sketch techniques specifically developed for biometric cryptography. This transformation converts Sarah's digital biometric representation into a fixed-length cryptographic key with a 256-bit value like “7f4e6a2d1c8b9a0f3e2d1c8b7a6f5e4d . . . ” This transformation has a crucial security property: it is one-way, meaning that even if someone obtained Sarah's Secret-Key, they could not reverse the process to determine her original biometric features. This protects her biometric privacy even in the unlikely event of a system breach. Additionally, the transformation includes error-correction mechanisms that allow the system to generate the same Secret-Key from future biometric samples even with slight variations in positioning or conditions, making the authentication process reliable while maintaining security.

At step 405, the processor 201 may be configured for creating a unique email address on the System-Controlled-Domain. The system generates a distinctive email address that will serve as the user's public identifier within the network. For Sarah, the system might create an address like “sarah.784fb9@securedomain.com” where “sarah” is derived from her registered name, “784fb9” is a unique identifier generated by the system (possibly a hash fragment of her account details), and “securedomain.com” is the System-Controlled-Domain. This address follows standard email formatting for familiarity and compatibility with existing systems, but functions fundamentally differently in terms of access control. The System-Controlled-Domain is managed exclusively by the system, allowing it to monitor and control all traffic attempting to reach these addresses. This architecture enables the enforcement of the permission-based messaging model at the domain level, creating a secure perimeter around all communications.

At step 406, the processor 201 may be configured for associating the unique email address with the user's Secret-Key to create their Gated-Email-Address. This step establishes the cryptographic binding between the user's biometric-derived identity and their public-facing address. For Sarah, the system creates a secure association between her Secret-Key (SKA1) and her email address “sarah.784fb9@securedomain.com”, transforming it into a Gated-Email-Address (GEA). This association might be implemented as a digital certificate or cryptographic binding that proves the email address is legitimately controlled by the holder of the corresponding Secret-Key. The technical advantage of this association is that it creates a verifiable link between Sarah's biometric identity and her public address without exposing her actual biometric data. The Gated-Email-Address functions as Sarah's Public Key in the system, allowing other users to reference and connect with her while the underlying biometric authentication remains private and secure.

At step 407, the processor 201 may be configured for storing this association in the system database. The system securely records the relationship between Sarah's identity and her Gated-Email-Address. Importantly, the system does not store Sarah's biometric data or even her Secret-Key (which remains derived from biometrics when needed). Instead, it stores the Gated-Email-Address and various metadata such as account creation time, account status, and public profile information. This database entry might look like: “User ID: SA-2025-05-20-001, Gated-Email-Address: sarah.784fb9@securedomain.com, Created: May 20, 2025, 13:45 UTC, Status: Active.” The technical advantage of this storage approach is that it maintains a persistent record of user identities necessary for system functionality while preserving biometric privacy through the absence of actual biometric data or private keys in any database. This significantly reduces the value of the database as a target for attackers, as compromising it would not yield private keys or biometric data that could be used to impersonate users.

Now referring to FIG. 5, a method 500 for connection establishment between users is illustrated, in accordance with an embodiment of the present subject matter.

At step 501, the processor 201 may be configured for receiving a connection request from User A to connect with User B. This step initiates the process of establishing a mutually whitelisted connection between two users. For example, Sarah (User A) decides to connect with her colleague Michael (User B). Within the System-App, Sarah navigates to “Add Connection” and enters an identifier for Michael, such as his phone number, email, or name. She then taps “Send Connection Request.” The system receives this request, which includes Sarah's Gated-Email-Address (GEA) as the source and the provided identifier for Michael as the target. Unlike traditional communication systems where Sarah could simply start sending messages to Michael without his prior consent, this connection request initiates a formal process to establish mutual permission before any communication can occur. The technical advantage is that the system enforces explicit consent from the outset, rather than requiring users to reactively block unwanted communications after they've already been received.

At step 502, the processor 201 may be configured for generating a unique invitation code. To secure the connection process, the system creates an invitation code specific to this particular connection attempt. For Sarah's request to connect with Michael, the system might generate a code like “INV-SA-MI-2025-05-20-H78B2”, which encodes information such as the initiator (Sarah), the recipient (Michael), the date, and a unique identifier. This invitation code serves as a one-time token for establishing this specific connection and cannot be reused for other connections. The system might also include an expiration time, after which the invitation becomes invalid if not accepted. This prevents old invitations from being used if found or intercepted at a later date. The unique nature of each invitation code provides a technical advantage by preventing replay attacks and ensuring that each connection establishment follows a proper authorization path.

At step 503, the processor 201 may be configured for encoding the invitation to be readable only by the System-App. The system transforms the invitation code into a format designed to be securely processed exclusively by the System-App. For example, the system might encrypt the invitation using the system's public key and then encode it as a QR code or specialized URL format like “securedomain://connect/Jh7G9Kf3sL0pQ2a . . . ” The encoding might include additional integrity checks and authenticating elements that the System-App can verify. When this encoded invitation is received on any device, only the authentic System-App can properly decrypt and process it. If someone attempts to scan the QR code with a regular QR scanner or open the specialized URL with a standard browser, they would not be able to extract or use the connection information. This provides a technical advantage by creating a secure channel for the invitation that cannot be intercepted or processed by malicious applications, even if the initial delivery mechanism (such as email or SMS) is not inherently secure.

At step 504, the processor 201 may be configured for transmitting the encoded invitation to User B. The system sends the encoded invitation to Michael through an available communication channel. For example, if Sarah provided Michael's phone number, the system might send an SMS message stating “Sarah would like to connect with you on SecureMessaging. To accept this invitation, download the System-App from [app store link] and use this code” followed by the encoded invitation, as a QR code image or specialized link. Alternatively, if Sarah provided Michael's email, the system would send an email with similar content. The message includes clear instructions for Michael to download the System-App if he doesn't already have it. The technical advantage here is that the system leverages existing communication channels for the initial contact while ensuring that the actual connection establishment can only occur through the secure System-App, creating a bridge from traditional communication methods to the secure messaging network.

At step 505, the processor 201 may be configured for detecting when User B installs the System-App. If Michael doesn't already have the System-App installed, the system monitors for his installation. When Michael clicks the app store link and installs the System-App, the system detects this installation through standard app installation tracking mechanisms. Upon first launch, the app might recognize that it was installed in response to an invitation and automatically prompt to scan or enter the invitation code. Alternatively, Michael might need to tap an “Accept Invitation” button and then scan the QR code or paste the specialized link he received. The system's ability to detect new installations enables a streamlined onboarding process tailored specifically for users joining in response to invitations, providing a technical advantage in user experience while maintaining security.

At step 506, the processor 201 may be configured for processing User B's biometric samples. As a new user, Michael needs to provide biometric samples to establish his secure identity within the system. Similar to Sarah's registration process, the System-App guides Michael through providing biometric samples such as a facial scan, fingerprint, or voice recording. The app might explain: “To establish your secure identity and accept Sarah's connection request, please complete the following biometric scan. Your biometric data remains on your device and is never stored or transmitted.” Michael's biometric samples are then processed following the same procedures used during user registration, i.e. extracting distinctive features, converting them to a digital representation, and applying a one-way transformation to generate his unique Secret-Key (SKB1). This approach ensures that all users in the system have equivalent security derived from their biometric identity, creating a network of authenticated individuals.

At step 507, the processor 201 may be configured for generating the Gated-Email-Address for User B. Following the same process used for Sarah, the system creates a unique email address for Michael on the System-Controlled-Domain, such as “michael.62a7d3@securedomain.com”, and associates it with his Secret-Key (SKB1). This Gated-Email-Address serves as Michael's Public Key in the system, allowing other users to reference him while keeping his biometric-derived Secret-Key private. The technical advantage of creating consistent Gated-Email-Addresses for all users is that it provides a familiar format for addressing while fundamentally transforming the security model from open-by-default to closed-by-default. Each Gated-Email-Address functions as a cryptographically secured endpoint rather than a traditional email address accessible to anyone.

At step 508, the processor 201 may be configured for receiving confirmation that User B has received and decoded the invitation. When Michael successfully scans or enters the invitation code in the System-App, the app decodes the invitation using the system's cryptographic protocols and displays details such as: “Connection request from: Sarah (sarah.784fb9@securedomain.com)” and prompts Michael to accept or decline. When Michael taps “Accept,” the System-App sends a secure confirmation back to the system indicating successful reception, decoding, and acceptance of the invitation. This confirmation includes Michael's newly created Gated-Email-Address (GEB) to complete the connection information. The system now has verified that both parties have explicitly consented to establish a connection, i.e. Sarah through her initial request and Michael through his acceptance.

At step 509, the processor 201 may be configured for validating the invitation. Before finalizing the connection, the system performs security checks on the invitation. It verifies that the invitation code “INV-SA-MI-2025-05-20-H78B2” is legitimate and was indeed issued by the system for a connection between Sarah and Michael. It checks that the invitation hasn't expired, hasn't already been used, and hasn't been tampered with during transmission. The system also verifies that the acceptance came from the intended recipient by comparing the provided identifier (phone number or email) used in the initial invitation with the account information associated with the acceptance. These validations ensure the integrity of the connection establishment process and prevent various security threats such as invitation forgery, replay attacks, or man-in-the-middle attempts.

At step 510, the processor 201 may be configured for generating the Shared Secrets for the relationship. With both users authenticated and the invitation validated, the system creates the cryptographic elements needed for secure communication. Using a standard cryptographic algorithm such as Elliptic Curve Diffie-Hellman (ECDH), the system generates two distinct Shared Secrets: a Shared Secret (ABSS) for Sarah's messages to Michael and a Shared Secret (BASS) for Michael's messages to Sarah. For example, the system might derive ABSS by combining Sarah's Secret-Key with Michael's Public Key, and BASS by combining Michael's Secret-Key with Sarah's Public Key. These keys might be 256-bit values that will be used for encrypting all future messages between them. The technical advantage of using separate secrets for each direction is that it provides perfect forward secrecy and compartmentalization if one direction is somehow compromised, the other remains secure. Additionally, these Shared Secrets are never transmitted over the network; they are calculated independently on each user's device using their own Secret-Key and the other user's Public Key.

At step 511, the processor 201 may be configured for appending records to the respective Whitelists of both users. The system creates explicit permission records documenting the established connection. It appends a Record (RAB) to Sarah's Whitelist (WA) that indicates Sarah has granted Michael permission to send her messages. Similarly, it appends a Record (RBA) to Michael's Whitelist (WB) reflecting his permission for Sarah to message him. These whitelist records contain essential information such as the Gated-Email-Addresses of both users, the timestamp of connection establishment, the connection path (direct, in this case), and references to the associated Shared Secrets. For example, Michael's entry in Sarah's Whitelist might be structured as: “Sender: michael.62a7d3@securedomain.com, Connected: May 20, 2025, 15:17 UTC, Connection Path: Direct, Status: Active, Shared Secret Reference: ABSS-SA-MI-471.” The technical advantage of these explicit whitelist records is that they create unambiguous, auditable permission grants that the system can check before delivering any message, fundamentally transforming messaging from the traditional open-by-default model to a secure permission-based model.

At step 512, the processor 201 may be configured for enabling message exchange between the users based on their updated Whitelists. With the mutual whitelisting complete, the system provisions the secure messaging channel between Sarah and Michael. This provisioning includes setting up the necessary protocols, encryption mechanisms, and delivery paths for their communications. When Sarah composes a message to Michael, the System-App encrypts it using their Shared Secret (ABSS) and sends it through the system's secure channels. Before delivering the message to Michael, the system checks his Whitelist (WB) to verify that Sarah has permission to message him. Similarly, when Michael responds, his message is encrypted with BASS, and the system checks Sarah's Whitelist (WA) before delivery. This whitelist verification happens for every message, ensuring continuous enforcement of user-defined communication permissions. The technical advantage of this approach is that it creates a messaging environment where unsolicited messages are technologically impossible, a fundamental redesign of digital communication that eliminates spam, prevents phishing attempts, and gives users complete control over their communications.

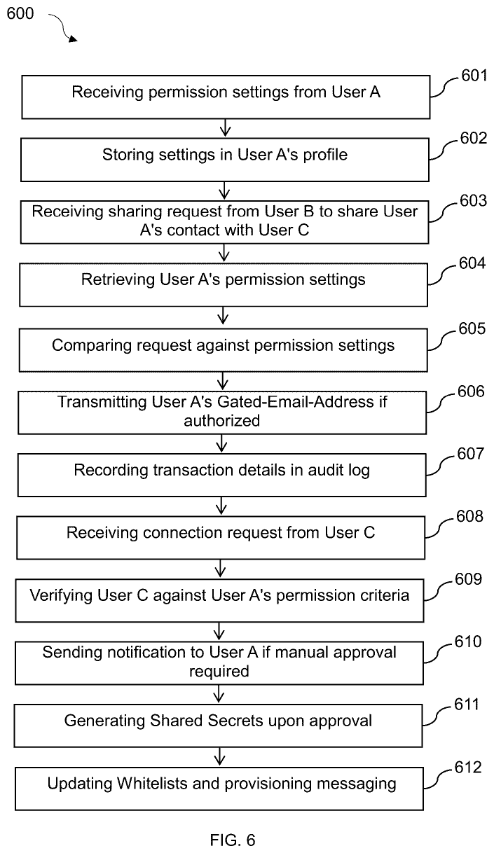

Now referring to FIG. 6, a method 600 for contact sharing with consent among users is illustrated, in accordance with an embodiment of the present subject matter.

At step 601, the processor 201 may be configured for receiving permission settings from User A. User A specifies detailed preferences for how their contact information can be shared with others. These settings include identifying specific users authorized to share User A's Gated-Email-Address, defining categories of third-party users who may receive the contact information, and specifying whether automatic or manual approval is required for resulting connection requests. For instance, a user might set “Only colleagues at my company can share my contact, and I require manual approval for all resulting connection requests.”

At step 602, the processor 201 may be configured for storing these permission settings in User A's profile. The system securely saves these settings in the database, associating them with User A's account to ensure consistent application across all sharing attempts. These settings are encrypted and can only be accessed through proper authentication within the System-App.

At step 603, the processor 201 may be configured for receiving a sharing request from User B to share User A's contact with User C. When User B attempts to share User A's Gated-Email-Address with User C through the System-App interface, the system intercepts this request before any sharing occurs. This interception ensures that User A's permission settings are evaluated before their contact information is distributed.

At step 604, the processor 201 may be configured for retrieving User A's permission settings from the database. The system accesses the stored preferences to determine whether this particular sharing attempt is permitted according to User A's specifications. This retrieval happens in real-time to ensure that the most current preferences are applied.

At step 605, the processor 201 may be configured for comparing the sharing request parameters against User A's permission settings. The system evaluates whether User B is authorized to share User A's contact and whether User C belongs to a category that User A has approved. This comparison might involve checking organizational affiliations, connection degrees, or other attributes specified in User A's settings. The technical advantage of this comparison is that it enforces User A's preferences before any sharing occurs, preventing unauthorized distribution of contact information.

At step 606, the processor 201 may be configured for transmitting User A's Gated-Email-Address to User C if the sharing request is authorized. If the sharing is permitted based on User A's settings, the system proceeds with the sharing action, allowing User C to receive User A's contact information. If the sharing is not authorized, the system blocks the attempt and notifies User B that the sharing could not be completed due to User A's preference settings.

At step 607, the processor 201 may be configured for recording details of the sharing transaction in an audit log. The system creates a comprehensive record of the sharing action, including the identities of all parties involved, the timestamp, and the outcome of the permission check. This audit trail provides transparency and accountability in how contact information propagates through the network, allowing users to trace how their information has been shared.

At step 608, the processor 201 may be configured for receiving a connection request from User C to connect with User A. After receiving User A's Gated-Email-Address, User C may initiate a connection request through the System-App. This request includes User C's own Gated-Email-Address and importantly, a reference to User B as the source of the contact, creating a traceable path of how the connection originated.

At step 609, the processor 201 may be configured for verifying whether User C meets the criteria specified in User A's permission settings. The system performs a multi-step verification: checking the relationship between User B and User C, evaluating any category-based rules that apply to User C, and determining whether automatic approval is authorized. This verification ensures that User A's preferences are respected throughout the network expansion process.

At step 610, the processor 201 may be configured for sending a notification to User A for approval if automatic approval is not authorized. If User A's settings require manual review for this type of connection, the system sends a notification with User C's identity information and the connection path through User B. This transparency allows User A to make an informed decision about accepting the connection request.

At step 611, the processor 201 may be configured for generating Shared Secrets for the relationship between User A and User C upon User A's approval. Similar to the process described in FIG. 5, the system creates cryptographic secrets for each direction of communication: ACSS for User A to User C and CASS for User C to User A. These secrets enable secure, encrypted communication between the newly connected users.

At step 612, the processor 201 may be configured for updating Whitelists and provisioning messaging between User A and User C. The system appends records to each user's Whitelist and enables secure message exchange based on these updated permissions. This completes the connection establishment process initiated through contact sharing, allowing User A and User C to begin exchanging messages securely.

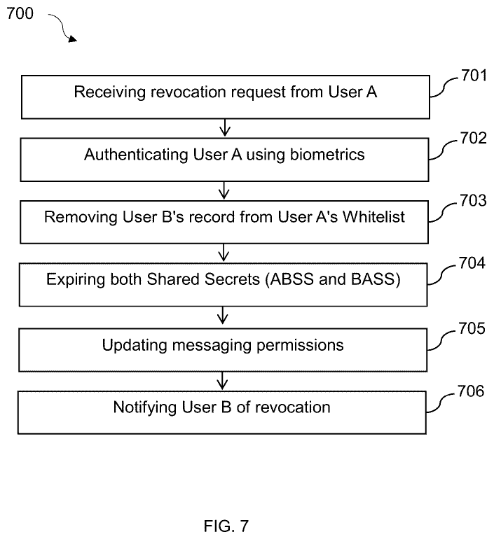

Now referring to FIG. 7, a method 700 for permission revocation in the mutually whitelisted messaging network is illustrated, in accordance with an embodiment of the present subject matter.

At step 701, the processor 201 may be configured for receiving a revocation request from User A to revoke User B's permission to send messages to User A. When User A decides to end the communication relationship with User B, they can initiate a revocation request through the System-App. The system receives this request and prepares to modify the permission structure between the users.

At step 702, the processor 201 may be configured for authenticating User A using biometrics to validate the revocation request. Before executing the revocation, the system requires User A to provide a fresh biometric sample for authentication. This verification ensures that only the legitimate account owner can revoke messaging permissions, protecting against unauthorized access or session hijacking attempts.

At step 703, the processor 201 may be configured for removing User B's record from User A's Whitelist. Once the revocation request is validated, the system removes the Record (RAB) from User A's Whitelist (WA). This record removal effectively withdraws User A's permission for User B to send messages, creating a technical barrier to further communication from User B to User A.

At step 704, the processor 201 may be configured for expiring the Shared Secrets between the users. The system invalidates both the Shared Secret (ABSS) specific to User A's relationship with User B and the Shared Secret (BASS) specific to User B's relationship with User A. This expiration renders the cryptographic keys invalid, preventing any further encrypted communication between the two users, even if attempted through alternative channels.

At step 705, the processor 201 may be configured for updating the messaging permissions throughout the system. The Messaging Module updates its permission records to reflect the revocation, ensuring that any attempt by User B to send messages to User A will be rejected at all system levels. This multi-layered enforcement ensures that the revocation is comprehensive and impossible to circumvent.

At step 706, the processor 201 may be configured for notifying User B that their messaging permission has been revoked. The system sends a notification to User B informing them that User A has revoked their permission to send messages. This notification provides clarity about the changed relationship status but does not require User B's acknowledgment or approval, as the revocation is unilateral and technologically enforced regardless of User B's response.

Now referring to FIG. 8, a method 800 for implementing messaging as stateful objects is illustrated, in accordance with an embodiment of the present subject matter.

At step 801, the processor 201 may be configured for creating a message object with a unique identifier when a first message is sent. Unlike traditional email where each message is a separate entity, the system creates a single persistent object for the entire conversation. When User A sends a message to User B, the system generates a unique identifier (e.g., “MSG-2025-05-20-001”) for this conversation and creates a message object that will evolve as the conversation continues.

At step 802, the processor 201 may be configured for storing the message object in a storage system accessible to all participants. The system stores this object in a secure database or distributed storage solution that all authorized participants can access. Unlike traditional email where copies are distributed to each recipient's inbox, this approach maintains a single source of truth for the conversation.

At step 803, the processor 201 may be configured for updating the state of the message object as participants interact with it. When participants reply or otherwise interact with the message, the system updates the state of the original message object rather than creating new separate messages. For example, when User B replies to User A's message, their response is added to the original message object as a new state, maintaining the conversation's continuity in a single evolving object.

At step 804, the processor 201 may be configured for tracking all changes to the message object with timestamps and user identifiers. The system records every modification to the message object, creating a complete audit trail of who said what and when. This tracking enables features like viewing message history or understanding the evolution of a discussion while maintaining accountability for all contributions.

At step 805, the processor 201 may be configured for synchronizing the message object state across all participants' devices. When any participant interacts with the message, the changes are propagated to all other participants in real-time or near-real-time. This synchronization ensures that all users are seeing the same current state of the conversation, eliminating the confusion that can arise when participants are viewing different versions of a thread.

At step 806, the processor 201 may be configured for rendering the current state of the message object to each participant. The system formats the message object for display in the System-App, showing the conversation in a clean, logical format that eliminates redundant content. Instead of showing repeated headers and quoted text from previous messages (as is common in email), the interface displays the conversation as a continuous thread with clear attribution for each contribution, dramatically improving readability and information density.

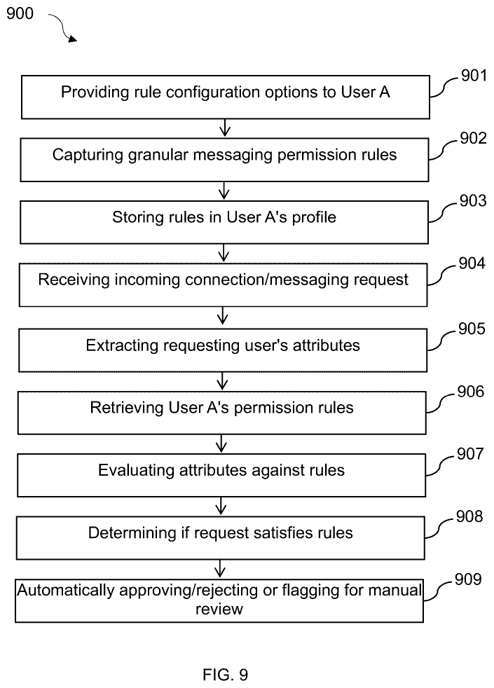

Now referring to FIG. 9, a method 900 for rule-based permissioning in the mutually whitelisted messaging network is illustrated, in accordance with an embodiment of the present subject matter.

At step 901, the processor 201 may be configured for providing rule configuration options to User A. The system presents a comprehensive interface for defining granular messaging permission rules. These options include connection-based rules (such as allowing only first and second-degree connections or extending to third-degree connections), organizational affiliation rules (enabling messages from specific companies or domains), temporal rules based on connection duration (such as requiring connections to exist for a minimum period before messaging is permitted), and attribute-based rules (allowing filtering based on user characteristics like professional role or verification status).

At step 902, the processor 201 may be configured for capturing the granular messaging permission rules specified by User A. As User A configures their preferences through the System-App interface, the system captures these rules in a structured format suitable for automated processing. The rule capture process validates the rules for logical consistency and provides feedback if contradictory rules are created, ensuring that the resulting ruleset will produce predictable and intended outcomes.

At step 903, the processor 201 may be configured for storing the rules in User A's profile. The system securely saves the granular permission rules in association with User A's account in the database. These rules become part of User A's security profile and will be automatically applied to all incoming connection or messaging requests without requiring manual intervention for each new interaction.

At step 904, the processor 201 may be configured for receiving an incoming connection or messaging request. When another user attempts to connect with or send a message to User A, the system intercepts this request and subjects it to the rule-based evaluation process before permitting the connection or message delivery. This interception ensures that all communications adhere to User A's defined preferences.

At step 905, the processor 201 may be configured for extracting relevant attributes of the requesting user. The system compiles a comprehensive profile of the user initiating the request, including their connection degree relative to User A, organizational affiliation, connection duration with mutual contacts, and any other attributes relevant to User A's rules. This information creates the basis for evaluating whether the request meets User A's criteria.

At step 906, the processor 201 may be configured for retrieving User A's granular permission rules. The system accesses the stored ruleset to apply it to the current request. This retrieval ensures that the most current version of User A's preferences is used for evaluation, allowing for dynamic rule updates that take immediate effect.

At step 907, the processor 201 may be configured for evaluating the requesting user's attributes against each rule. The system systematically compares the extracted attributes against each rule in User A's permission set. This evaluation might involve checking whether the requesting user is within the permitted connection degrees, belongs to approved organizations, has been connected to mutual contacts for sufficient time, or possesses other required attributes specified by User A.

At step 908, the processor 201 may be configured for determining whether the request satisfies the permission rules. Based on the evaluation results, the system makes a determination about the request's compliance with User A's preferences. This determination considers all applicable rules and their logical relationships (such as AND/OR conditions) to reach a conclusive decision about whether the request should be permitted, rejected, or flagged for manual review.

At step 909, the processor 201 may be configured for automatically approving or rejecting the request, or flagging it for manual review. Based on the determination from the previous step and User A's preferences for automatic handling, the system takes appropriate action. Requests that clearly satisfy all rules might be automatically approved, those that clearly violate rules might be automatically rejected with an appropriate notification, and those falling into ambiguous or specified-for-review categories are flagged and presented to User A for manual decision.

Now referring to FIG. 10, a method 1000 for security enforcement against traditional email protocols is illustrated, in accordance with an embodiment of the present subject matter.

At step 1001, the processor 201 may be configured for monitoring incoming email traffic to the System-Controlled-Domain. The system continuously scans all incoming SMTP traffic directed to addresses within its controlled domain. This monitoring captures any attempts to communicate with Gated-Email-Addresses using traditional email protocols rather than the secure System-App channels. For example, if someone attempts to send a standard email to “user.123abc@securedomain.com,” this monitoring system would intercept it before delivery.

At step 1002, the processor 201 may be configured for identifying messages directed to Gated-Email-Addresses. Within the monitored traffic, the system specifically identifies messages addressed to Gated-Email-Addresses (GEA/GEB) registered in the system. This identification process distinguishes between regular emails that might legitimately be handled by standard protocols and those attempting to reach addresses that require the secure, permission-based messaging framework of the system.

At step 1003, the processor 201 may be configured for flagging unauthorized access attempts. When the system detects messages attempting to reach Gated-Email-Addresses through traditional protocols, it marks these as unauthorized access attempts. These flags trigger the system's security response mechanisms and may also contribute to security analytics that help identify patterns of attempted circumvention.

At step 1004, the processor 201 may be configured for generating rejection notices for unauthorized attempts. For each unauthorized access attempt, the system creates a standardized but informative rejection notice. These notices explain that the Gated-Email-Address cannot be reached through traditional email protocols and requires the use of the System-App with proper permissions. The notices might include a link to download the System-App and instructions on how to properly request connection permission.

At step 1005, the processor 201 may be configured for returning the rejection notices to senders using traditional email protocols. The system sends the generated rejection notices back to the original senders through standard email channels. This provides immediate feedback to the sender about why their message was not delivered and offers guidance on the proper communication method if they wish to connect with the intended recipient.

At step 1006, the processor 201 may be configured for logging blocked access attempts for security analysis. The system maintains detailed records of all blocked access attempts, including the sender information, timestamp, targeted Gated-Email-Address, and other relevant metadata. These logs serve multiple purposes: they help identify potential security threats or patterns of abuse, provide audit trails for system administration, and can inform users about attempted unauthorized communications to their Gated-Email-Addresses. The technical advantage of this comprehensive logging is that it creates transparency around attempted circumvention of the permission-based messaging system, allowing for both reactive and proactive security measures.

Although implementations for the system 101 and the method 300 for operating a mutually whitelisted messaging network have been described in language specific to structural features and methods, it must be understood that the claims are not limited to the specific features or methods described. Rather, the specific features and methods are disclosed as examples of implementations for the system 101 and the method 300 for operating a mutually whitelisted messaging network.

1. A system for operating a mutually whitelisted messaging network, wherein the system comprises:
a processor; and
a memory coupled to the processor, wherein the processor is configured to execute instructions stored in the memory for:
receiving, by a registration module, a set of biometric samples from a User A via a System-App installed on User A's device;
processing, by a key generation module, the set of biometric samples to generate a Secret-Key (SKA1) for the User A, wherein the Secret-Key (SKA1) is unique to the User A;
generating, by an address generation module, a Gated-Email-Address (GEA) for the User A by
creating a unique email address on a System-Controlled-Domain; and
associating the unique email address with the Secret-Key (SKA1), wherein the unique email address is treated as the Gated-Email-Address (GEA), wherein the Gated-Email-Address (GEA) is the User A's Public Key;
receiving, by an invitation module, a first connection request from User A to connect with User B;
generating, by the invitation module, a unique invitation and encoding the unique invitation to generate an encoded unique invitation, wherein the encoded unique invitation is configured to be readable only by the System-App;
transmitting, by a communication module, the encoded unique invitation to User B, wherein the encoded unique invitation includes instructions for User B to download and install the System-App;
detecting, by an onboarding module, when User B installs the System-App and captures User B's biometric samples;
processing, by the key generation module, User B's biometric samples to generate a Secret-Key (SKB1) for the User B, wherein the Secret-Key (SKB1) is unique to the User B;
generating, by the address generation module, a Gated-Email-Address (GEB) for User B by creating a unique address on the System-Controlled-Domain and associating the Gated-Email-Address (GEB) with the generated Secret-Key (SKB1), wherein the Gated-Email-Address (GEB) is User B's Public Key;
receiving, by a connection module, data from the System-App on User B's device indicating that User B has received and decoded the encoded unique invitation;
validating, by the connection module, the encoded unique invitation sent by User A to User B;
generating, by a cryptographic module, a Shared Secret (ABSS) specific to User A's relationship with User B by applying a standard cryptographic algorithm;
generating, by the cryptographic module, a Shared Secret (BASS) specific to User B's relationship with User A by applying the standard cryptographic algorithm;
appending, by the connection module, a Record (RAB) to a Whitelist (WA) of User A, wherein the Record (RAB) reflects User A's permission to User B for sending messages to User A;
appending, by the connection module, a Record (RBA) to a Whitelist (WB) of User B, wherein the Record (RBA) reflects User B's permission to User A for sending messages to User B; and
provisioning, by a messaging module, User A and User B to exchange messages based on Whitelist (WA) and Whitelist (WB).

2. The system of claim 1, wherein processing the biometric samples to generate the respective Secret-Keys (SKA1/SKB1) comprises steps of:
extracting distinctive biometric features from the biometric samples;
converting the extracted distinctive biometric features into a digital representation; and
applying a one-way transformation to the digital representation to generate the respective Secret-Keys (SKA1/SKB1).

3. The system of claim 1, wherein the processor is further configured to execute instructions for:
receiving, by a permission module, input from User A specifying permission settings for sharing User A's Gated-Email-Address (GEA), wherein the permission settings include:
(i) specific users who are authorized to share User A's Gated-Email-Address (GEA);
(ii) categories of third-party users who may receive User A's Gated-Email-Address (GEA); and
(iii) whether automatic or manual approval is required for resulting connection requests;
storing, by the permission module, the permission settings in association with User A's profile on the System-App in a database;
receiving, by a sharing module, a sharing request from User B to share User A's Gated-Email-Address (GEA) with User C;
retrieving, by the permission module, User A's permission settings from the database;
comparing, by the permission module, the sharing request parameters against User A's permission settings to determine if the sharing request is authorized;
transmitting, by the sharing module, to User C, User A's Gated-Email-Address (GEA), when the sharing request is authorized; and
recording, by the sharing module, details of a permission sharing transaction in an audit log, including the identities of all parties involved, the timestamp, and the outcome of permission check.

4. The system of claim 3, wherein the processor is further configured to execute instructions for:
receiving, by a connection request module, a second connection request from User C to connect with User A, wherein the second connection request includes User C's Gated-Email-Address (GEC) and a reference to User B as the source of the contact;
verifying, by the permission module, whether User C meets the criteria specified in User A's permission settings by:
(i) checking the relationship between User B and User C;
(ii) evaluating any category-based rules that apply to User C; and
(iii) determining whether automatic approval is authorized;
transmitting, by a notification module, a connection request notification to User A's System-App when automatic approval is not authorized, wherein the notification includes User C's identity information and a connection path through User B;
generating, by the cryptographic module, based on User A's approval on the second connection request:
(i) a Shared Secret (ACSS) specific to User A's relationship with User C using the standard cryptographic algorithm; and
(ii) a Shared Secret (CASS) specific to User C's relationship with User A using the standard cryptographic algorithm;
appending, by the connection module, a record to the Whitelist (WA) of User A, reflecting User A's permission to User C for sending messages to User A;
appending, by the connection module, a record to a Whitelist (WC) of User C, reflecting User C's permission to User A for sending messages to User C; and
provisioning, by the messaging module, User A and User C to exchange messages based on the Whitelist (WA) and the Whitelist (WC).

5. The system of claim 1, wherein the processor is further configured to execute instructions for:
receiving, by a revocation module, a revocation request from User A to revoke User B's permission for sending messages to User A;
validating, by an authentication module, that the revocation request is genuinely from User A by performing biometric authentication of User A;
removing, by the connection module, the Record (RAB) from the Whitelist (WA) of User A, when the revocation request is validated;
expiring, by the cryptographic module, the Shared Secret (ABSS) specific to User A's relationship with User B and the Shared Secret (BASS) specific to User B's relationship with User A;
updating, by the messaging module, the messaging permissions to disallow message transmission between User A and User B; and
notifying User B, by a notification module, that User B's messaging permission has been revoked by User A.

6. The system of claim 1, wherein the processor is further configured to execute instructions for:
providing User A, by a rule configuration module, with options to define granular messaging permission rules specifying which categories of users can send messaging requests to User A, wherein the options include:
(i) connection messaging permission rules, wherein the connection messaging permission rules correspond to:
first and second-degree connections,
first, second, and third degree connections;
(ii) organizational affiliation rules;
(iii) temporal rules based on connection duration; and
(iv) attribute-based rules;
receiving, by a rule capture module, the granular messaging permission rules specified by User A;
storing, by the permission module, the granular messaging permission rules in association with User A's profile on the System-App;
processing, by a rule evaluation module, incoming messaging permission requests by:
(i) extracting relevant attributes of the requesting user,
(ii) retrieving User A's granular messaging permission rules,
(iii) evaluating the requesting user's attributes against each rule from the granular messaging permission rules, and
(iv) determining whether the request satisfies the granular messaging permission rules; and
automatically approving or rejecting the incoming messaging permission request based on the evaluation of the granular messaging permission rules, or flagging the incoming messaging permission request for manual review when the granular messaging permission rules specify manual approval.

7. The system of claim 1, wherein messages exchanged using the messaging module are implemented as stateful objects through the steps of:
creating, by a message creation module, a message object with a unique identifier when a first message is sent;
storing, by a storage module, the message object in a storage system accessible to all participants;
updating, by a state management module, a state of the message object as participants interact with the message object, rather than creating new message objects for replies;
tracking, by a version control module, all changes to the message object with timestamps and user identifiers;
synchronizing, by a synchronization module, the message object state across all participants' devices; and
rendering, by a presentation module, the current state of the message object to each participant, thereby eliminating redundant content in the display.

8. The system of claim 1, wherein the processor is further configured to execute instructions for:
preventing, by a security enforcement module, any attempts to send messages between User A and User B through traditional email protocols by:
monitoring, by a traffic monitoring module, incoming email traffic to the System-Controlled-Domain;
identifying, by an email analysis module, messages directed to Gated-Email-Addresses (GEA/GEB); and
returning, by a notification module, rejection notices to senders attempting to use traditional email protocols.

9. A method for operating a mutually whitelisted messaging network, wherein the method comprises steps of:
receiving, by a registration module, a set of biometric samples from a User A via a System-App installed on User A's device;
processing, by a key generation module, the set of biometric samples to generate a Secret-Key (SKA1) for the User A, wherein the Secret-Key (SKA1) is unique to the User A;
generating, by an address generation module, a Gated-Email-Address (GEA) for the User A by
creating a unique email address on a System-Controlled-Domain; and
associating the unique email address with the Secret-Key (SKA1), wherein the unique email address is treated as the Gated-Email-Address (GEA), wherein the Gated-Email-Address (GEA) is the User A's Public Key;
receiving, by an invitation module, a first connection request from User A to connect with User B;
generating, by the invitation module, a unique invitation and encoding the unique invitation to generate an encoded unique invitation, wherein the encoded unique invitation is configured to be readable only by the System-App;
transmitting, by a communication module, the encoded unique invitation to User B, wherein the encoded unique invitation includes instructions for User B to download and install the System-App;
detecting, by an onboarding module, when User B installs the System-App and captures User B's biometric samples;
processing, by the key generation module, User B's biometric samples to generate a Secret-Key (SKB1) for the User B, wherein the Secret-Key (SKB1) is unique to the User B;
generating, by the address generation module, a Gated-Email-Address (GEB) for User B by creating a unique address on the System-Controlled-Domain and associating the Gated-Email-Address (GEB) with the generated Secret-Key (SKB1), wherein the Gated-Email-Address (GEB) is User B's Public Key;
receiving, by a connection module, data from the System-App on User B's device indicating that User B has received and decoded the encoded unique invitation;
validating, by the connection module, the encoded unique invitation sent by User A to User B;
generating, by a cryptographic module, a Shared Secret (ABSS) specific to User A's relationship with User B by applying a standard cryptographic algorithm;
generating, by the cryptographic module, a Shared Secret (BASS) specific to User B's relationship with User A by applying the standard cryptographic algorithm;
appending, by the connection module, a Record (RAB) to a Whitelist (WA) of User A, wherein the Record (RAB) reflects User A's permission to User B for sending messages to User A;
appending, by the connection module, a Record (RBA) to a Whitelist (WB) of User B, wherein the Record (RBA) reflects User B's permission to User A for sending messages to User B; and
provisioning, by a messaging module, User A and User B to exchange messages based on Whitelist (WA) and Whitelist (WB).

10. A computer program product for operating a mutually whitelisted messaging network, the computer program product comprising a non-transitory computer-readable storage medium having program instructions embodied therewith, wherein the program instructions are executable by a processor for:
receiving, by a registration module, a set of biometric samples from a User A via a System-App installed on User A's device;
processing, by a key generation module, the set of biometric samples to generate a Secret-Key (SKA1) for the User A, wherein the Secret-Key (SKA1) is unique to the User A;
generating, by an address generation module, a Gated-Email-Address (GEA) for the User A by
creating a unique email address on a System-Controlled-Domain; and
associating the unique email address with the Secret-Key (SKA1), wherein the unique email address is treated as the Gated-Email-Address (GEA), wherein the Gated-Email-Address (GEA) is the User A's Public Key;
receiving, by an invitation module, a first connection request from User A to connect with User B;
generating, by the invitation module, a unique invitation and encoding the unique invitation to generate an encoded unique invitation, wherein the encoded unique invitation is configured to be readable only by the System-App;
transmitting, by a communication module, the encoded unique invitation to User B, wherein the encoded unique invitation includes instructions for User B to download and install the System-App;
detecting, by an onboarding module, when User B installs the System-App and captures User B's biometric samples;
processing, by the key generation module, User B's biometric samples to generate a Secret-Key (SKB1) for the User B, wherein the Secret-Key (SKB1) is unique to the User B;
generating, by the address generation module, a Gated-Email-Address (GEB) for User B by creating a unique address on the System-Controlled-Domain and associating the Gated-Email-Address (GEB) with the generated Secret-Key (SKB1), wherein the Gated-Email-Address (GEB) is User B's Public Key;
receiving, by a connection module, data from the System-App on User B's device indicating that User B has received and decoded the encoded unique invitation;
validating, by the connection module, the encoded unique invitation sent by User A to User B;
generating, by a cryptographic module, a Shared Secret (ABSS) specific to User A's relationship with User B by applying a standard cryptographic algorithm;
generating, by the cryptographic module, a Shared Secret (BASS) specific to User B's relationship with User A by applying the standard cryptographic algorithm;
appending, by the connection module, a Record (RAB) to a Whitelist (WA) of User A, wherein the Record (RAB) reflects User A's permission to User B for sending messages to User A;
appending, by the connection module, a Record (RBA) to a Whitelist (WB) of User B, wherein the Record (RBA) reflects User B's permission to User A for sending messages to User B; and
provisioning, by a messaging module, User A and User B to exchange messages based on Whitelist (WA) and Whitelist (WB).
